(19) United States
(12) Patent Application Publication
(10) Pub. No.: US 2007/0214179 A1
(43) Pub. Date: Sep. 13, 2007

(54) SEARCHING, FILTERING, CREATING, DISPLAYING, AND MANAGING ENTITY RELATIONSHIPS ACROSS MULTIPLE DATA HIERARCHIES THROUGH A USER INTERFACE

(76) Inventor: Khanh Hoang, Westminster, CA (US)

Correspondence Address: ADELI LAW GROUP, A PROFESSIONAL LAW CORPORATION, 1875 CENTURY PARK EAST, SUITE 1360, LOS ANGELES, CA, 90067, US

(21) Appl. No.: 11/617,684

(22) Filed: Dec. 28, 2006

Related U.S. Application Data
(60) Provisional application No. 60/781,481, filed on Mar. 10, 2006.

(51) Int. Cl. G06F 7/00

(52) U.S. Cl. 707/104.1

(57) ABSTRACT

A method and system for searching, filtering, creating, displaying, and managing entity relationships from a repository of data hierarchies through a user interface is provided. Relationships of a primary entity and its related secondary entities are retrieved and displayed in a unified view in graphical or text view. The unified view may indicate a “cross” relationship between first and second entities through another entity that connects the first and second entities, the first and second entities originating from different data hierarchies and/or data sources. Relationships of a selected secondary entity may be displayed in a unified view and entities or relationships may be updated or stored to a separate storage area. The method and system may be used within an enterprise for implementing Master Data Management or Customer Data Integration for managing data hierarchies containing customer information, human capital information, supplier information, asset information, product information, or financial information.

### CLAIM OF BENEFIT TO PRIOR APPLICATION

This application claims benefit to U.S. Provisional Patent Application 60/781,481, filed on Mar. 10, 2006, which is incorporated herein by reference.

### FIELD OF THE INVENTION

The present invention relates to the field of data management, and in particular, to searching, filtering, creating, displaying, and managing entity relationships across multiple data hierarchies through a user interface.

### BACKGROUND OF THE INVENTION

One of the key assets an enterprise has is the data it captures about its customers and their interactions with these customers. Data regarding a particular customer and his/her interactions/relationships are typically created by various enterprises using software applications that provide a solution for a single business function, product line or touch point, the data being stored in a plurality of disparate and independent data sources. This results in applications and data sources that are managed independently and do not share data well with one another. Also, the applications and data sources often have different data models and means of tracking and reporting customer interactions, leaving enterprises with islands of difficult-to-reconcile relationship data. As such, data regarding a customer is strewn across multiple applications and data sources in different lines of business or product divisions. Due to this data dispersion, it is difficult for an enterprise to obtain a comprehensive view of a customer and his/her interactions with the various enterprises.

The lack of a comprehensive view of customers drives a variety of business problems. Marketing, sales, finance, call-center, and service agents lack a complete understanding or overview of the customer's interactions with other enterprises. As such, opportunities to drive new revenues or increase profitability are lost, for example, when new potential customers or opportunities are not linked and identified. Opportunities are also lost when cross-sell and up-sell recommendations are based on generic offers or inaccurate or incomplete data about an individual customer. Operational, compliance, and credit risk increases as organizations lack a comprehensive understanding of customer relationships.

Conventionally, enterprises have been unable to properly leverage available customer data stored in multiple data source locations and can only obtain a fragmented view of a customer and the customer's relationships with various enterprises. As such, there is a need for a method for leveraging all of the available customer data to create and maintain a unified and comprehensive view of a customer across multiple disparate data sources.

### SUMMARY OF THE INVENTION

A method and apparatus for searching, filtering, creating, displaying, and managing entity relationships across multiple data hierarchies through a user interface is provided. In some embodiments, the method retrieves a primary entity from a repository of multiple data hierarchies that originate from multiple data sources. The method then retrieves entities (secondary entities) related to the primary entity and the specific relationships (primary relationships) between the primary entity and the various secondary entities from across multiple hierarchies in the repository according to received search parameters. The method then displays a unified and comprehensive view of the primary entity, the primary relationships, and the secondary entities. The unified view may be displayed in a graphical view or text view in the user interface. In some embodiments, a unified view indicates a “cross” relationship between first and second entities through at least one other entity that connects/links the first and second entities, the first and second entities originating from different hierarchies and/or data sources.

In some embodiments, the method also retrieves entities (associated entities) related to a selected secondary entity and the specific relationships (secondary relationships) between the secondary entity and the various associated entities from across multiple hierarchies in the repository according to received search parameters. The method then displays the search results in a unified view in the user interface. In some embodiments, the method filters the unified view according to received filter parameters and displays the filtered results. In some embodiments, the method is used to update one or more entities or relationships in the unified view according to received updated data (e.g., to modify, remove, or add an entity or relationship). In further embodiments, the method copies and stores the contents (entities and relationships) of the unified view to a new hierarchy or separate “sandbox” storage area, receives modifications to the unified view in the sandbox, and stores the modified unified view to the repository of data hierarchies.

The method and apparatus provides a more comprehensive view of an entity across multiple channels, business lines and, enterprises, where there are multiple sources of entity data in multiple systems and data sources. The method and apparatus allow a user to view, analyze, and manage relationships across multiple hierarchies from different data sources and to identify potential opportunities or clients through cross relationships that are displayed in the unified view.

In some embodiments, the method and apparatus is used within an enterprise for implementing Enterprise Information Management (EIM), Master Data Management (MDM), or Customer Data Integration (CDI). In some embodiments, EIM and MDM are the management of various domains of master data that may include customer information management (CIM), human capital information management (HCIM), supplier information management (SIM), asset information management (AIM), product information management (PIM), or financial information management (FIM). In these embodiments, the user interface method and apparatus is used for searching, filtering, creating, displaying, and managing entity relationships across multiple data hierarchies containing these various domains of master data (e.g., customer information, human capital information, supplier information, asset information, product information, or financial information).

### BRIEF DESCRIPTION OF THE DRAWINGS

The novel features of the invention are set forth in the appended claims. However, for purpose of explanation, several embodiments of the invention are set forth in the following figures.

FIG. 1 illustrates a conceptual diagram of a system in which some embodiments operate.

FIG. 2 shows a conceptual example of a data hierarchy comprising a plurality of entities and relationships.

FIG. 3 illustrates a conceptual diagram of an alternative system in which some embodiments operate.

FIG. 4 is an exemplary flowchart of a general method for searching, displaying, and managing entities and relationships from multiple data hierarchies.

FIGS. 5A-F are exemplary screen shots of the hierarchy manager user interface.

FIG. 6 is a flowchart of a primary entity search method used to locate and retrieve primary entities from multiple hierarchies.

FIGS. 7A-D and 8A-B are exemplary screen shots that illustrate steps of the primary entity search method of FIG. 6.

FIGS. 9A-B are flowcharts of a unified view build and display method used to build out and display a unified view of entities and relationships from multiple hierarchies.

FIGS. 10A-C are exemplary screen shots that illustrate steps of the unified view build and display method of FIGS. 9A-B.

FIG. 11 shows a conceptual diagram of a search for direct and indirect relationships across two data hierarchies.

FIGS. 12A-B, 13A-C, and 14A-B are exemplary screen shots that illustrate steps of the unified view build and display method of FIGS. 9A-B.

FIG. 15 is an exemplary flowchart of an update method used to update entity and relationship information.

FIGS. 16A-E are exemplary screen shots that illustrate steps of the update method of FIG. 15.

FIG. 17 is an exemplary flowchart of a sandbox method used to copy and store contents of a unified view.

FIGS. 18A-C are exemplary screen shots that illustrate steps of the sandbox method of FIG. 17.

FIGS. 19A-D are exemplary screen shots that illustrate searching entities related to a selected entity.

FIGS. 20A-D are exemplary screen shots that illustrate adding several relationships to an entity in a bulk operation.

FIGS. 20D-20F are exemplary screen shots that illustrate reassigning several relationships from one entity to anther entity in a bulk operation.

FIG. 21 presents a computer system with which some embodiments are implemented.

### DETAILED DESCRIPTION OF THE INVENTION

In the following description, numerous details are set forth for purpose of explanation. However, one of ordinary skill in the art will realize that the invention may be practiced without the use of these specific details. In other instances, well-known structures and devices are shown in block diagram form in order not to obscure the description of the invention with unnecessary detail.

A method and apparatus for searching, filtering, creating, displaying, and managing entity relationships across multiple data hierarchies through a user interface is provided. In some embodiments, the method retrieves a primary entity from a repository of multiple data hierarchies that originate from multiple data sources. The method then retrieves entities (secondary entities) related to the primary entity and the specific relationships (primary relationships) between the primary entity and the various secondary entities from across multiple hierarchies in the repository according to received search parameters. The method then displays a unified and comprehensive view of the primary entity, the primary relationships, and the secondary entities. The unified view may be displayed in a graphical view or text view in the user interface. In some embodiments, a unified view indicates a “cross” relationship between first and second entities through at least one other entity that connects/links the first and second entities, the first and second entities originating from different hierarchies and/or data sources.

In some embodiments, the method also retrieves entities (associated entities) related to a selected secondary entity and the specific relationships (secondary relationships) between the secondary entity and the various associated entities from across multiple hierarchies in the repository according to received search parameters. The method then displays the search results in a unified view in the user interface. In some embodiments, the method filters the unified view according to received filter parameters and displays the filtered results. In some embodiments, the method is used to update one or more entities or relationships in the unified view according to received updated data (e.g., to modify, remove, or add an entity or relationship). In further embodiments, method copies and stores the contents (entities and relationships) of the unified view to a new hierarchy or separate “sandbox” storage area, receives modifications to the unified view in the sandbox, and stores the modified unified view to the repository of data hierarchies.

The method and apparatus provides a more comprehensive view of an entity across multiple channels, business lines and, enterprises, where there are multiple sources of entity data in multiple systems and data sources. The method and apparatus allow a user to view, analyze, and manage relationships across multiple hierarchies from different data sources and to identify potential opportunities or clients through cross relationships that are displayed in the unified view.

In some embodiments, the method and apparatus is used within an enterprise for implementing Enterprise Information Management (EIM), Master Data Management (MDM), or Customer Data Integration (CDI). In some embodiments, EIM and MDM are the management of various domains of master data that may include customer information management (CIM), human capital information management (HCIM), supplier information management (SIM), asset information management (AIM), product information management (PIM), or financial information management (FIM). In these embodiments, the user interface method and apparatus is used for searching, filtering, creating, displaying, and managing entity relationships across multiple data hierarchies containing these various domains of master data (e.g., customer information, human capital information, supplier information, asset information, product information, or financial information).

In the discussion below, Section I provides an introduction to general terms and an overview of a data management system comprising multiple data sources, a master reference manager, and a hierarchy manager. Section II provides a general overview of various functions of the hierarchy manager in searching, filtering, creating, displaying, and managing relationships across multiple hierarchies and an introduction to the hierarchy manager user interface. Section III describes a search and view function of the hierarchy manager that searches for related entities across multiple hierarchies and provides a unified/comprehensive view of these entities. Section IV describes an update function of the hierarchy manager that updates entities or relationships using the unified view. Section V describes a “sandbox” function that stores a separate copy of the unified view for modifying the unified view. Section VI describes a search related entities function that searches for entities related to a selected entity based on a single or several search parameters. Section VII describes bulk operations of adding a set of relationship to a target entity or reassigning a set of relationship from one entity to another entity. Finally, section VIII describes a computer system with which some embodiments are implemented.

### I. General Terms and Data Management System

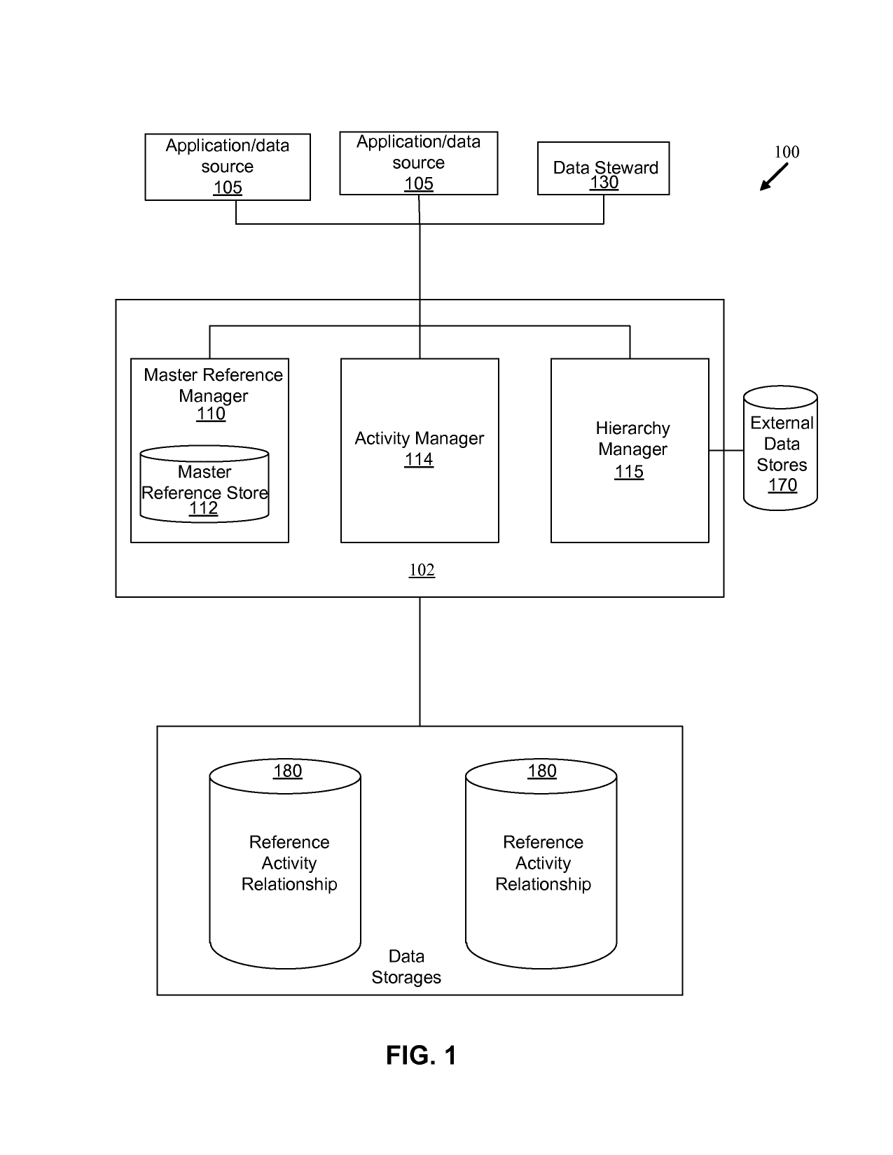

FIG. 1 illustrates a conceptual diagram of a system 100 in which some embodiments operate. In some embodiments, the system 100 is used within an enterprise for implementing Enterprise Information Management (EIM), Master Data Management (MDM), or Customer Data Integration (CDI). The system 100 includes multiple applications/data sources 105, a data steward 130, a master reference manager 110, an activity manager 114, a hierarchy manager 115, external data stores 170, and one or more data storages 180. The master reference manager 110, activity manager 114, and hierarchy manager 115 comprise a data management system 102.

The data storages 180 store (1) data that identifies the entities that the system tracks for the enterprise, (2) data that specifies the interaction of these entities with the enterprise, and (3) data that identifies the relationship between the entities. As mentioned above, the data that identifies the entities is referred to as reference data, the data that specifies the interactions and transactions with the entities is referred to as activity data, and the data that identifies the relationship between the entities is referred to as relationship data.

The data storages 180 may store multiple reference data records for a particular entity. This redundant data may cause problems for an enterprise that uses the data. For instance, the redundant data may contain inconsistencies or overlaps that need to be resolved to ensure the reliability of the data. Therefore, in some embodiments, the system stores a “best version” of the reference data for at least some of the entities. The “best version” of data (e.g., reference or relationship data) is referred to below as the “master data.” In some embodiments, the master reference manager 110 stores and maintains these best versions in a master reference store 112. For instance, the master reference manager 110 updates the reference data records in the master reference store 112 to reflect any changes to the reference data records in the data storages. The operation of the master reference manager is further described in U.S. Patent Application US2004/0006506 A1 published on Jan. 8, 2004. This application is incorporated herein by reference.

In the system 100, each application 105 captures data regarding entities and interactions (relationships) of the entities. In some embodiments, this data includes customer information, human capital information, supplier information, asset information, product information, or financial information. This captured data is also received by the data management system 102. The master reference manager 110 manages entity/reference data and the activity manager 114 manages activity data. When an application initiates a particular interaction regarding a particular entity, the activity manager 114 provides to the particular application a composite data object containing reference and activity data regarding the particular entity.

A composite data object typically includes a reference data object and an activity data object, the reference data object being sent to the activity manager 114 from the master reference manager 110. The particular application uses interaction data regarding the particular interaction in the activity data object of the composite data object that it receives from the activity manager 114. After using the transaction data, the application may temporarily or permanently store the composite data object, or data extracted from this object, in one or more data sources 105 and/or data storages 180.

Each application typically arranges entity and relationship data in one or more data hierarchies that are relevant to the application. For example, an organization's sales application data may store relationships about customer entities that are relevant to sales activities only. As such, each data source 105 contains original data for one or more data hierarchies, each data hierarchy comprising a set of entities and a set of relationships between the entities. The multitude of data sources may be captured and maintained by any number of different organizations, enterprises, individuals, etc. and may reside at any location that is internal or external to the location where the data management system 102 operates. A data source 105 comprises any resource that contains such original captured data (e.g., data warehouses, data marts, databases, data silos, applications, etc.).

Data regarding an entity is sometimes referred to herein as “entity data” or “reference data” and includes any data and/or meta-data that describes or identifies an entity. As used herein, an entity refers to anything that can be related to another thing and can be described with associated data. Although this list is non-exhaustive, examples of entities are organizations, enterprises, companies, customers, individuals, services, accounts, products, etc. Types of captured entity data/information vary depending on the entity type. For example, entity data/information for an individual may comprise the name, residence address, date of birth, social security number, and/or residence telephone number of the individual. If the entity is an organization, entity data/information may comprise, for example, the name, business address, state of incorporation, and/or the business telephone number of the organization.

Data regarding a relationship is sometimes referred to herein as “relationship data” and includes any data and/or meta-data that describes or identifies a relationship between two or more entities. Reference data and relationship data are non-transaction data. “Activity data,” on the other hand, is data that is associated with transactions or interactions of an entity. Relationship data, however, can be closely related to activity data since the relationship between two or more entities is often based on an activity, e.g., transaction or interaction. Some examples of relationship types are individual to individual (e.g., individual 1 is the accountant of individual 2), individual to organization (e.g., individual is an employee of organization), individual to account (e.g., individual is signer of account), organization to organization (e.g., organization 1 is a subsidiary of organization 2), etc. Other relationship data/information include direction of relationship, start date, end date, and role. Direction of a relationship indicates which entity is pointing to the other, for example, if the entities are in a parent-child relationship then the direction is from child to parent. For example, a first entity may point to a second entity, the second entity being the parent of the first entity. Start date, end date, and role are part of the attributes of a relationship.

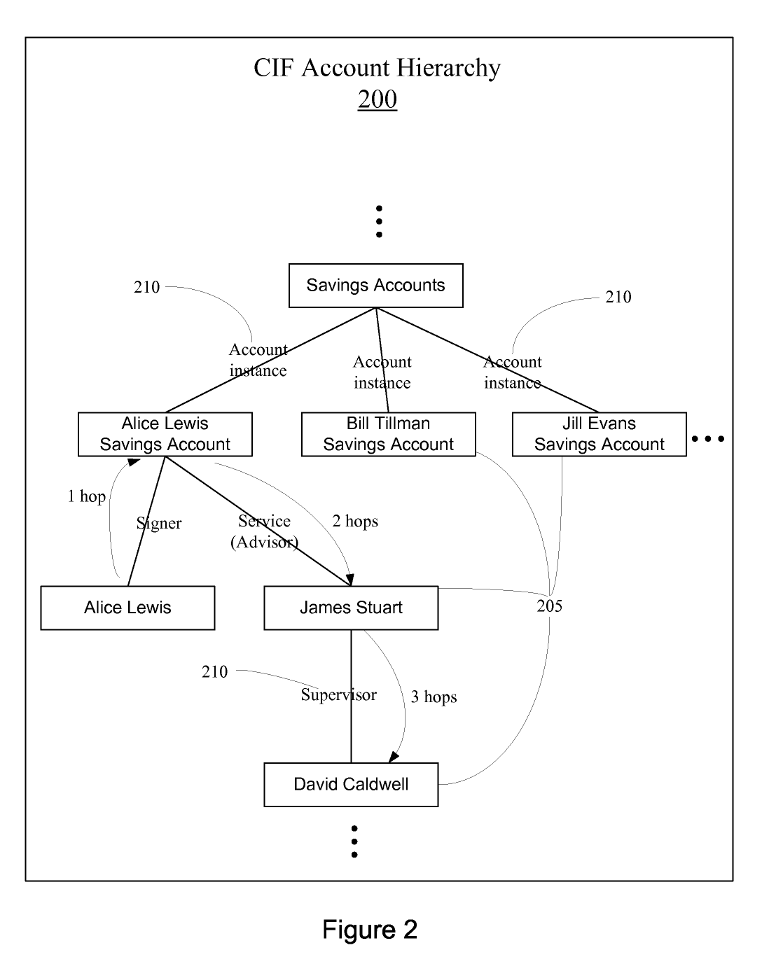

The entities (i.e., entity data) in each data source 105 are typically ordered and stored in one or more hierarchical structures (data hierarchies) based on the relationships (i.e., relationship data) between the entities. FIG. 2 shows a conceptual example of a data hierarchy 200 (“CIF Account”) comprising a plurality of entities 205 and a plurality of relationships 210 between the entities. Depending on the relationships between the entities, two particular entities in the data hierarchy 200 can have various hierarchical relationships relative to each other. For example, two particular entities may have a direct relationship (e.g., a direct parent-child relationship) such that no intermediary entity is needed to establish a connection/relationship between the two entities. For example, the entity “Alice Lewis” has a direct relationship (direct parent-child relationship) with the entity “Alice Lewis Savings Account” since no intermediary entity is needed to establish a connection/relationship between the two entities. Similarly, a relationship may be directly related to an entity when no intermediary entity is needed to establish a connection between the relationship and the entity. For example, the Signer relationship is directly related to the entity “Alice Lewis” since no intermediary entity is needed to establish a connection between the two. Such a direct relationship is sometimes referred to herein as a “one hop” relationship.

In contrast, two particular entities may have an indirect relationship such that one or more intermediary entities are needed to establish a connection/relationship between the two entities. For example, the entity “Alice Lewis” has an indirect relationship with the entity “James Stuart” since an intermediary entity (“Alice Lewis Savings Account”) is needed to establish a connection/relationship between the two entities. As a further example, the entity “Alice Lewis” has an indirect relationship with the entity “Dave Caldwell” since two intermediary entities (“Alice Lewis Savings Account” and “James Stuart”) are needed to establish a connection/relationship between the two entities. Similarly, a relationship may be indirectly related to an entity when one or more intermediary entities are needed to establish a connection between the relationship and the entity. For example, the “Service” relationship is indirectly related to the entity “Alice Lewis” since the “Alice Lewis Savings Account” intermediary entity is needed to establish a connection between the two. Such an indirect relationship is sometimes referred to herein as a “multi-hop” relationship.

As used herein, a “data hierarchy” or “hierarchy” refers to a set of entity data and a set of relationship data and the hierarchical structure in which the sets of data are ordered relative to each other. A data hierarchy originates from a particular application/data source 105. As such the terms “data hierarchy” and “data source” are sometimes used interchangeably. An identifier/name of a hierarchy typically comprises the identifier/name of the data source in which the hierarchy was initially stored and from which the hierarchy originates (such data source being referred to as the originating data source). As such, the identifier/name of a hierarchy typically indicates from which data source it originated (e.g., the “CIF Account” hierarchy most likely originates from the “CIF Account” data source). In other embodiments, however, the identifier/name of a hierarchy is different from the identifier/name of its originating data source.

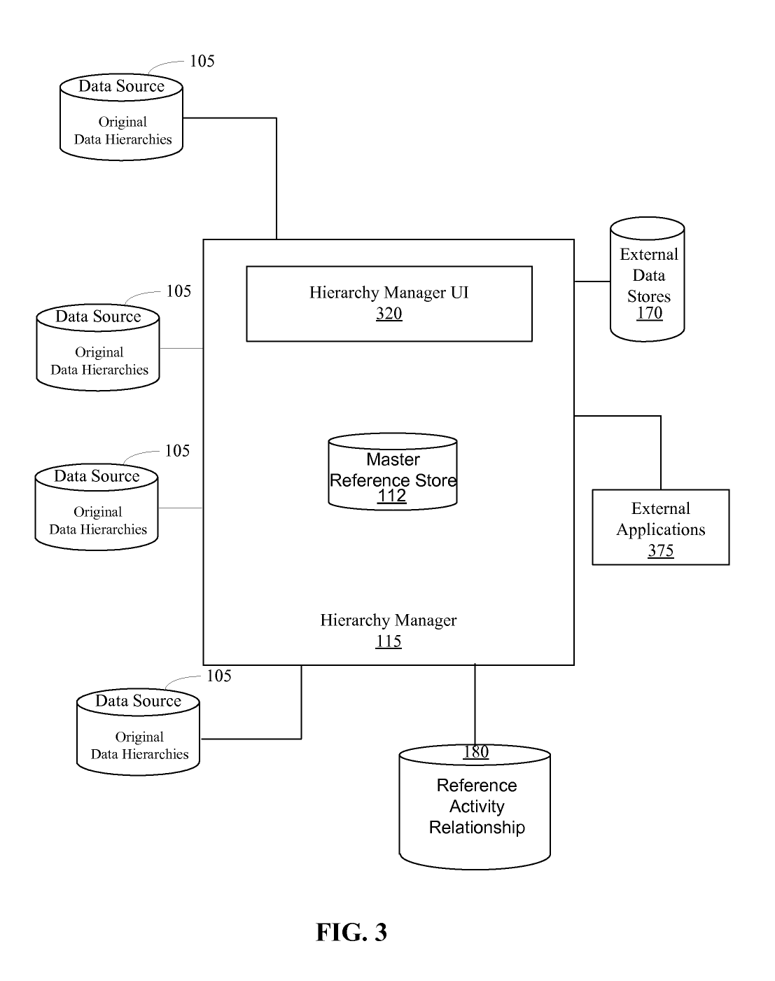

The hierarchy manager 115 processes data hierarchies of the various applications/data sources 105 and enables export of normalized hierarchical relationship data into external data stores 170 (as discussed below in relation to FIG. 3). In some embodiments, the data management system 102 stores reference/entity data and relationship hierarchy data to the master reference store 112 and/or one or more data storages 180.

FIG. 3 illustrates a conceptual diagram of processes performed by the hierarchy manager 115. The hierarchy manager 115 loads the original captured data (i.e., data hierarchies) from the multiple applications/data sources 105 and stores the original data to the master reference store 112 and/or data storage 180. In some embodiments, for each data hierarchy stored to the master reference store 112 and/or data storage 180, information/data regarding the originating data source of the data hierarchy is also stored to the master reference store 112 and/or data storage 180 and is associated with the data hierarchy (e.g., an identifier/name of an originating data source of a data hierarchy is associated with the data hierarchy).

In some embodiments, the hierarchy manager 115 performs other operations on the original data before storing it to the master reference store 112 and/or data storage 180. For example, the hierarchy manager 115 may perform (1) delta detection (detecting whether a change has occurred in the data), (2) standardization (homogenizing different data codifications), (3) schema mapping (projecting incoming data from a source schema onto a target schema, (4) vocabulary management (e.g., defining syntax of a target model), and/or (5) cleansing (removing superfluous data). The hierarchy manager 115 may also store trust metadata, the trust metadata comprising trust scores calculated based on a predetermined set of rules. The hierarchy manager 115 may also perform a merge operation on the original data before storing. The merge operation receives entity and relationship data from two or more different data hierarchies and integrates the data into a single integrated/merged data hierarchy based on shared/common entities between the two or more data hierarchies. Entity and relationship data stored in the hierarchy manager 115 can be exported to outside systems such as external data stores 170 or external applications 375. Specific embodiments of the hierarchy manager 115 are described in further detail in U.S. patent application Ser. No. 11/325,612, filed Jan. 3, 2006. This application is incorporated herein by reference.

The hierarchy manager 115 further comprises a hierarchy manager user interface (UI) 320 that allows a user to interact with entity and relationship data stored to the master reference store 112 and/or data storage 180 and to search, filter, create, view, and manage relationships across multiple data hierarchies. In some embodiments, the multiple data hierarchies originate from multiple different data sources 105 and are stored to the master reference store 112 and/or data storage 180. In some embodiments, two or more data hierarchies have been merged into a single integrated data hierarchy and stored to the master reference store 112 and/or data storage 180. In other embodiments, the hierarchy manager operates directly on the different data sources 105 without use of the master reference store 112 and/or data storage 180. In these embodiments, none of the data hierarchies have been merged to form integrated data hierarchies and each comprise an independent and separate data hierarchy.

Regardless of whether the data hierarchies are stored to the data storage 180 or not, or whether the data hierarchies include integrated data hierarchies or not, the hierarchy manager operates on entity and relationship data that, prior to any integration/merging of data hierarchies, originated from a plurality of different data hierarchies. The set of all data hierarchies that are available to the hierarchy manager for access and processing (whether this set of hierarchies is stored in their respective originating data sources or stored in the master reference store 112 and/or data storage 180) is referred to as a repository of data hierarchies. In some embodiments, the repository of data hierarchies includes data regarding customer information, human capital information, supplier information, asset information, product information, or financial information. As used herein, a function that operates across multiple data hierarchies in the repository indicates that the function operates on multiple data hierarchies that were originally captured and created as independent and separate data hierarchies. As such, if a function operates on a single integrated/merged data hierarchy that is an integration of two or more original data hierarchies, the function is still considered to operate across multiple data hierarchies in the repository since the integrated/merged data hierarchy was originally two or more independent and separate data hierarchies.

One of ordinary skill will recognize that variations may occur in the arrangement of the system 100 of FIG. 1 or the hierarchy manager 115 of FIG. 3. For instance, the activity manager 114 and the hierarchy manager 115 are drawn in parallel on the same layer in FIG. 1 for purposes of representation. In other embodiments, the activity manager 114 can reside on top of hierarchy manager 115 as a separate module or be partially implemented in the same module. Specific embodiments of the master reference manager 110 and the activity manager 114 are described in further detail in U.S. Patent Application US2004/0006506 A1 (published Jan. 8, 2004) and U.S. patent application Ser. No. 11/169,319, filed Jun. 27, 2005, both Applications being incorporated herein by reference. Specific embodiments of the hierarchy manager 115 are described in further detail in U.S. patent application Ser. No. 11/325,612, filed Jan. 3, 2006, the Application being incorporated herein by reference.

### II. General Overview of Hierarchy Manager Functions and User Interface Hierarchy Manager Functions:

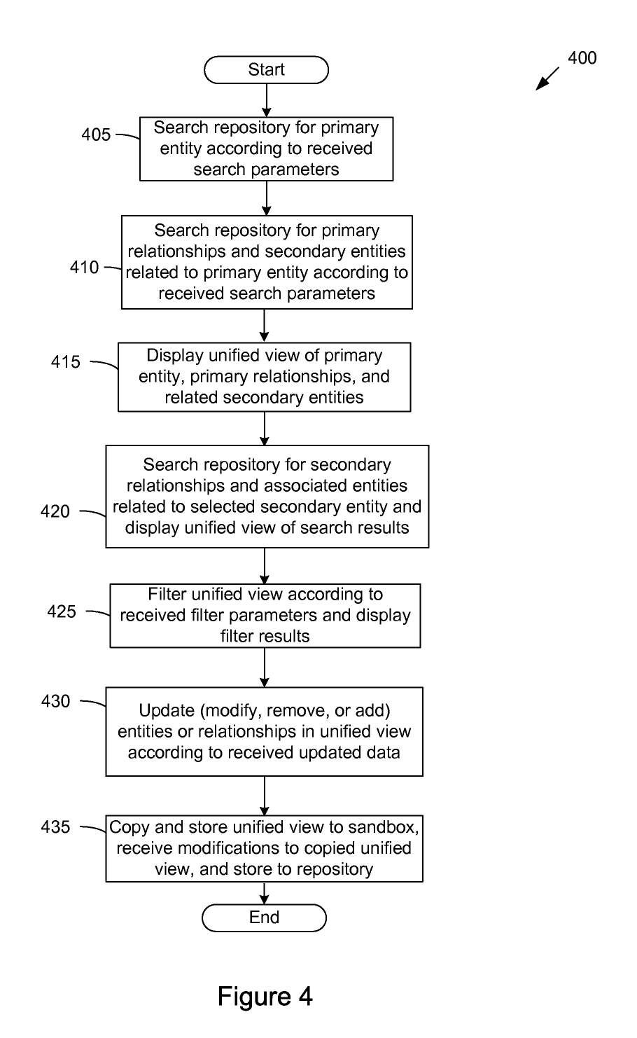

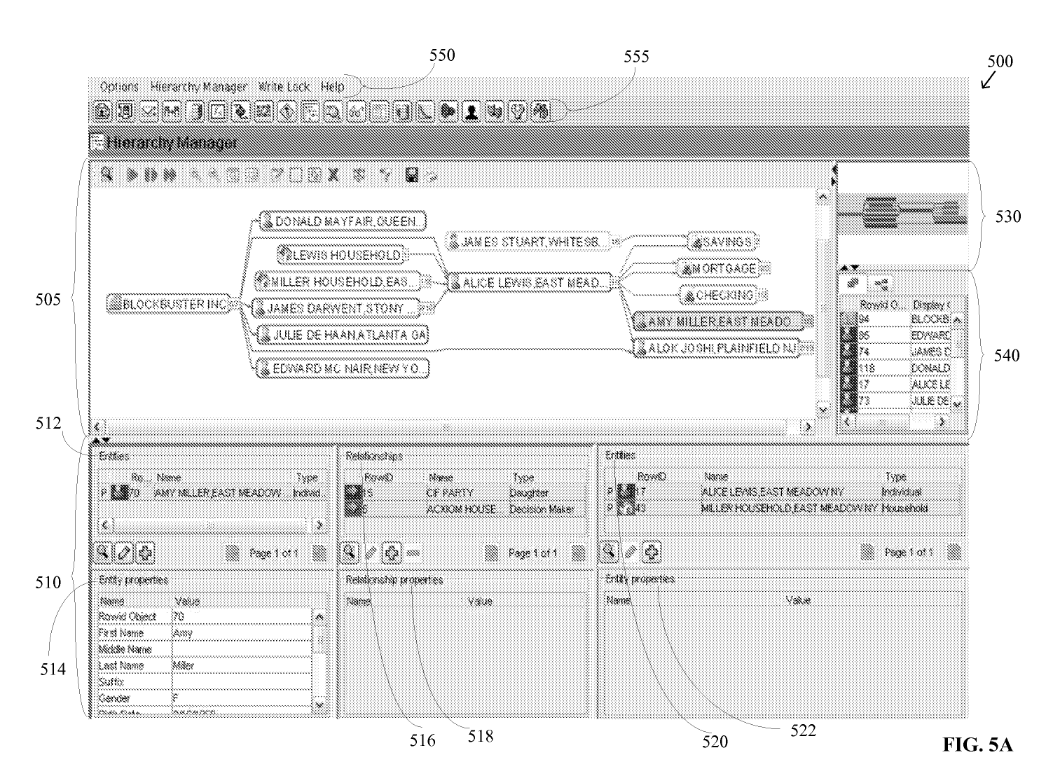

FIG. 4 is a flowchart of a general method 400 for searching, filtering, creating, displaying, and managing relationships across multiple data hierarchies in a repository of data hierarchies through use of a user interface. The method 400 is a process that conceptual illustrates a process of interacting with a user interface. In some embodiments, the hierarchy manager is configured to perform various steps of the general method 400. The general method 400 contains method steps that illustrate the various functions of the hierarchy manager that can be accessed through the hierarchy manager UI and are shown to be performed in a particular sequence order for example purposes only. In other embodiments, the method steps are performed in a different sequence order. In some embodiments, the hierarchy manager and hierarchy manager UI are used within an enterprise for implementing Enterprise Information Management (EIM), Master Data Management (MDM), or Customer Data Integration (CDI) for managing data hierarchies containing customer information, human capital information, supplier information, asset information, product information, or financial information.

The general method 400 operates on a repository of data hierarchies, each data hierarchy comprising data regarding a plurality of entities and a plurality of relationships between the entities. The method 400 begins by searching for and retrieving (at 405) a particular entity (referred to as a primary entity) from across multiple hierarchies in the repository according to received search parameters. The method then searches for and retrieves (at 410) entities related to the primary entity (referred to as secondary entities) and the specific relationships (referred to as primary relationships) between the primary entity and the various secondary entities from across multiple hierarchies in the repository according to received search parameters. The method 400 then displays (at 415) a unified and comprehensive view/image of the primary entity, the primary relationships, and the secondary entities. The unified view/image may be displayed in a graphical view or text view.

As used herein, a primary entity generally refers to a selected entity of interest that is used as a basis or starting point of a repository search, where relationships of the primary entity and entities related to the primary entity are searched. As used herein, a secondary entity generally refers to an entity that is related to a selected entity of interest (the primary entity) and has a specific associated relationship (primary relationship) with the selected entity of interest. As used herein, a unified view/image of a primary entity is a view that displays/indicates the relationships of the primary entity and the secondary entities related to the primary entity, the relationships and secondary entities originating from two or more different data hierarchies.

The method 400 then searches for and retrieves (at 420) relationships of a selected secondary entity (referred to as secondary relationships) and entities related to the secondary entity (referred to as associated entities) from across multiple hierarchies in the repository according to received search parameters. (Note that since a secondary entity is the basis of a search here, the secondary entity could also be considered a primary entity and the associated entities could be considered secondary entities.) The method also displays (at 420) the search results in a unified view. The method then filters (at 425) the unified view according to received filter parameters and displays the filter results.

The method 400 then updates (at 430) one or more entities or relationships in the unified view according to received updated data that, for example, modifies, removes, or adds an entity or relationship. At step 435, the method 400 then copies and stores the contents (entities and relationships) of the unified view to a separate “sandbox” storage area, receives modifications to the unified view copied in the sandbox, and stores the modified entities and relationships of the modified unified view to the repository (e.g., to the master reference store 112 and/or data storage 180) to replace the current data stored for the modified entities and relationships in the repository. The method then ends.

### Hierarchy Manager User Interface:

The hierarchy manager provides a user interface (UI) that allows a user to search, view, and manage entity relationships across multiple hierarchies of the repository. A user interacts with the hierarchy manager UI using input devices (e.g., alphanumeric keyboards, cursor-controllers, etc). The user may select and manipulate items displayed in the hierarchy manager UI using methods well known in the art (e.g., clicking on the item, dragging and dropping the item, etc.) and may specify functions to be performed on a selected item using methods well known in the art (e.g., by right-clicking on the item to reveal function options, using pull down menus, selecting toolbar items, etc.).

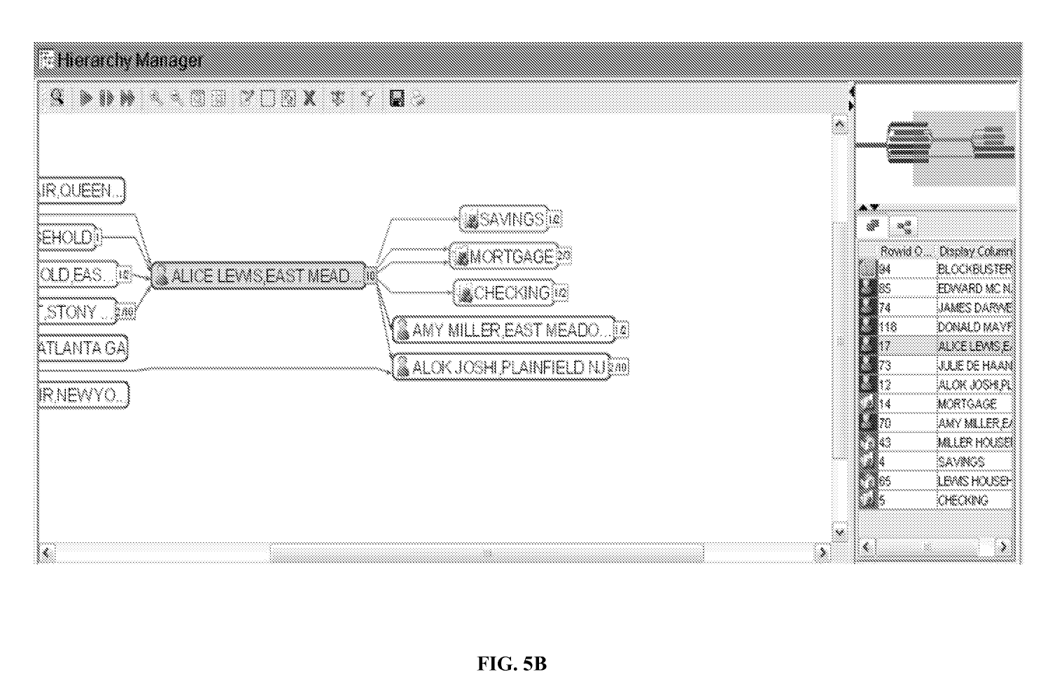

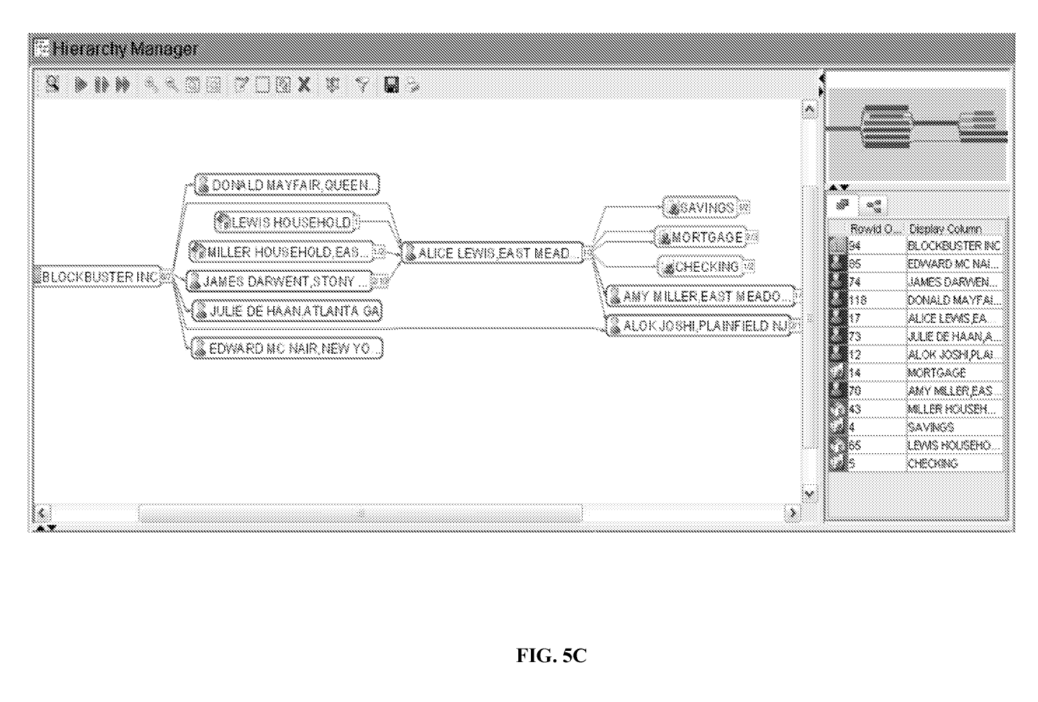

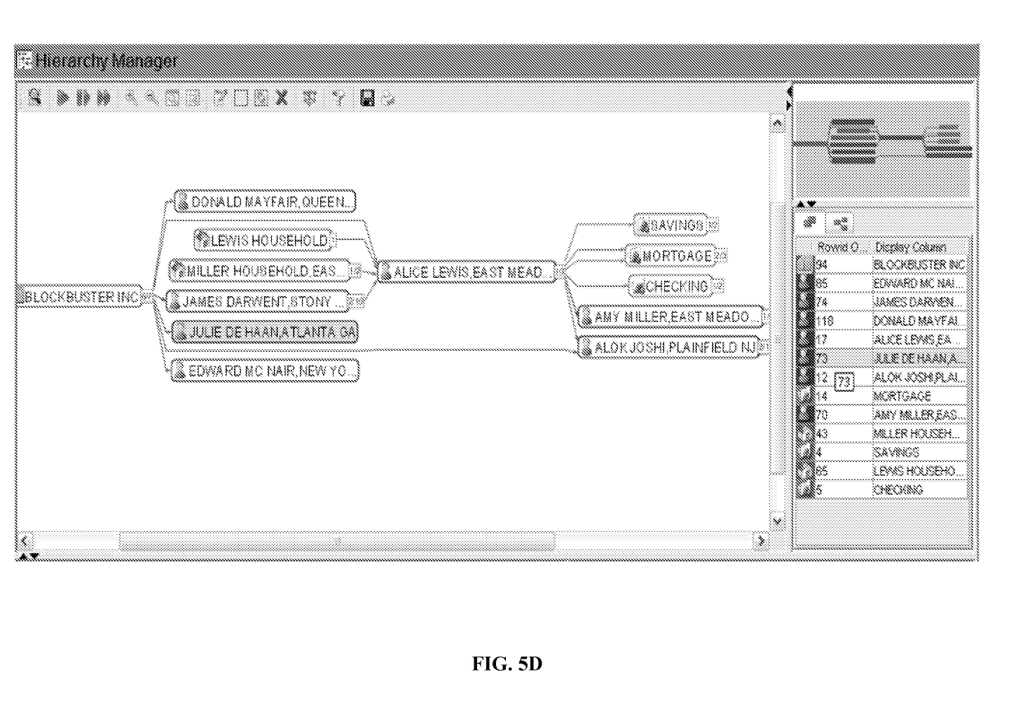

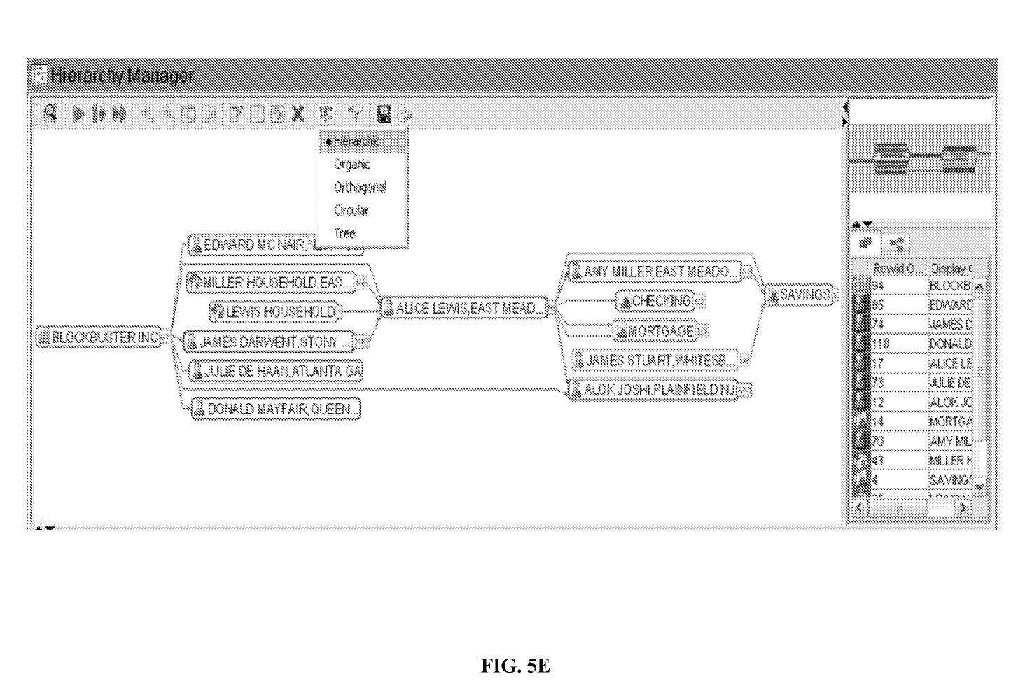

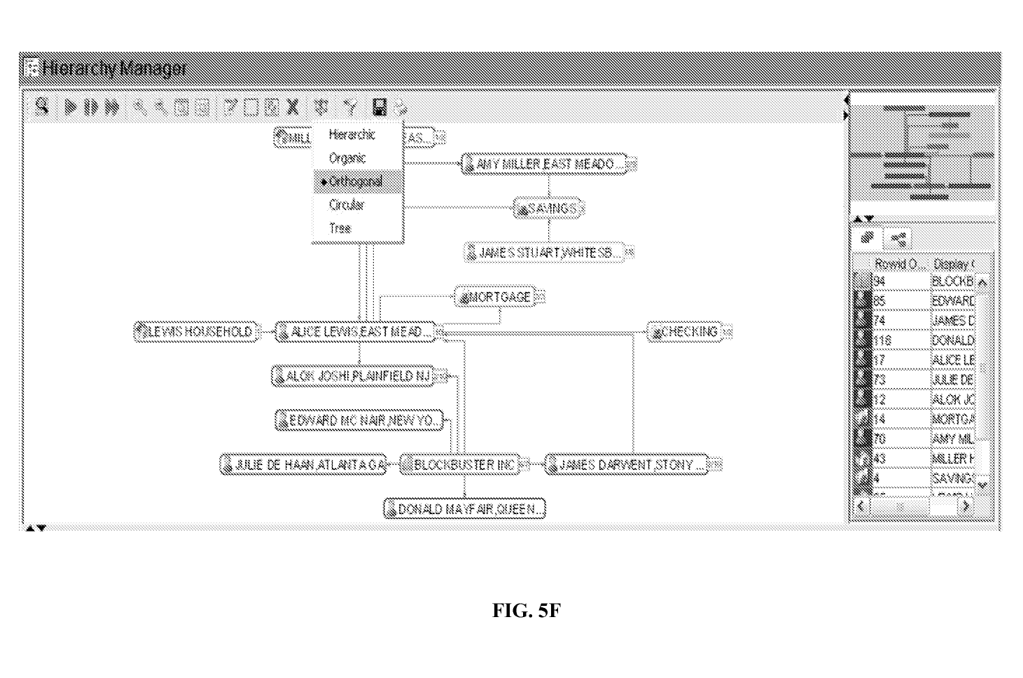

FIGS. 5A-F are exemplary screen shots of the hierarchy manager UI 500. As shown in FIG. 5A, the hierarchy manager UI 500 comprises a graphical view pane 505, a text view pane 510, an aerial view pane 530, and an entity listing pane 540. The hierarchy manager UI 500 also comprises various pull down menus 550 and toolbar buttons 555 that allow a user to specify functions to be performed on a selected item in the hierarchy manager UI 500. The hierarchy manager UI also comprises multiple scroll bars and scroll buttons to navigate the views shown in the various panes and regions of the hierarchy manager UI.

The graphical view pane 505 provides a graphical view of a unified view/image of entities and relationships. Through the hierarchy manager UI, a user can interact with graphical representations of the entities and relationships displayed in the graphical view pane 505 to build out (i.e., search for, retrieve, and import relationships and related entities), filter, create, view, or manage entities and relationships. In some embodiments, the graphical view comprises a graph having node representations of entities and connector representations of the relationships between the entities. In some embodiments, a “cross” relationship between first and second entities that is established through a third entity is indicated in the graph by a connector representation of a relationship between the first and third entities, the node representation of the third entity, and a connector representation of the relationship between the second and third entities (as discussed further below). In some embodiments, text is also used in the graph to display information regarding the entities and/or relationships (e.g., to identify/specify the entities and/or relationships).

As shown in the example of FIG. 5A, various entities are represented as rectangle shaped nodes having text that identifies the represented entity. Also, relationships are shown as arrowed lines connecting two related entities. In other embodiments, the entities and relationships are represented by other polygons or graphical forms. In the example shown in FIG. 5A, the unified view displayed in the graphical view pane 505 comprises an Alice Lewis entity as a primary entity (displayed in the middle) with various related secondary entities (e.g., Blockbuster, Savings, Mortgage, etc.) displayed around the Alice Lewis primary entity.

In some embodiments, the direction of an arrowed line connecting two entities indicates a particular hierarchical relationship between the two entities. For example, in some embodiments, the direction of the arrowed line indicates the direction from a child entity to a parent entity. In some embodiments, the direction of the arrowed line indicates the direction from a parent entity to a child entity. As shown in FIG. 5A, an arrowed line points from a Lewis Household entity to the Alice Lewis entity indicating that the Lewis Household entity is a child of the Alice Lewis entity. As a further example, an arrowed line points from the Alice Lewis entity to a Mortgage entity indicating that the Alice Lewis entity is a child of the Mortgage entity. In other embodiments, the arrowed line between two entities indicates a different hierarchical relationship between the two entities.

The text view pane 510 provides a text view of a unified view of a primary entity. In some embodiments, the text view comprises a set of text items that specify entities and relationships. As in the graphical view pane 505, a user can interact with entities and relationships (using methods well known in the art) displayed in the text view pane 510 to build out (i.e., search for, retrieve, and import relationships and related entities), view, or manage entities and relationships. The text view pane 510 comprises a plurality of regions, each region displaying a particular type of text item. In some embodiments, the text view pane 510 comprises a primary entity region 512, a primary entity information region 514, a relationship region 516, a relationship information region 518, a secondary entity region 520, and a secondary entity information region 522. In some embodiments, the placement of a text item in a particular region of the unified view in the text view pane 510 indicates whether the text item specifies a primary entity, a secondary entity, or a relationship.

The primary entity region 512 contains text items that specify primary entities, and the primary entity information region 514 contains text items that specify entity information regarding a selected primary entity displayed in the primary entity region 512. The relationship region 516 contains text items that specify relationships between a primary entity displayed in the primary entity region 512 and a secondary entity displayed in the secondary entity region 520, and the relationship information region 518 contains text items that specify relationship information regarding a selected relationship displayed in the relationship region 516. The secondary entity region 520 contains text items that specify secondary entities related to a primary entity displayed in the primary entity region 512, and the secondary entity information region 522 contains text items that specify entity information regarding a selected secondary entity displayed in the secondary entity region 520.

Various methods can be used to enter a primary entity to be specified/displayed in the primary entity region 512. In some embodiments, a user enters a primary entity into the text view pane 510 by dragging and dropping a representation of the entity from the graphical view pane 505 to the primary entity region 512. In other embodiments, other methods are used. In some embodiments, after an entity is entered into the primary entity region 512 of the text view pane 510 (and is thus considered a primary entity), the hierarchy manager automatically builds (i.e., searches for and retrieves primary relationships and secondary entities) and displays a unified view of the primary entity in the text view pane 510 (i.e., displays text items that specify the primary relationships in the relationship region 516 and text items that specify the secondary entities in the secondary entity region 520).

In the example of FIG. 5A, an Amy Miller entity from the graphical view pane 505 has been dragged and dropped to the primary entity region 512. (Note that any information regarding the Amy Miller primary entity is displayed in the primary entity information region 514.) The hierarchy manager thus automatically builds and displays a unified view of the Amy Miller primary entity in the text view pane 510, i.e., by retrieving and displaying the Alice Lewis and Miller Household entities in the secondary entity region 520 and the Daughter relationship (originating from a CIF Party hierarchy) and Decision Maker relationship (originating from a Acxiom House hierarchy) in the relationship region 516. The Daughter relationship is placed on the same row level as the Alice Lewis entity to indicate that it is the associated relationship between the Alice Lewis secondary entity and the Amy Miller primary entity.

In FIG. 5A, note that the unified view of the Amy Miller entity in the text view pane 510 comprises several aspects: 1) placement of the Amy Miller entity in a particular region of the unified view (the primary entity region 512) to indicate it is a primary entity; 2) placement of the Alice Lewis and Miller Household entities in a particular region of the unified view (the secondary entity region 520) to indicate that these are secondary entities related to the Amy Miller entity; 3) placement of the Daughter and Decision Maker relationships in a particular region of the unified view (the relationship region 516) to indicate that these are primary relationships of the Amy Miller entity; and 4) through the display and placement of the entities and relationships in the particular regions of the unified view, a “cross” relationship between the Alice Lewis and Miller Household entities is indicated by the Daughter relationship between the Alice Lewis and Amy Miller entities, the Decision Maker relationship between the Alice Lewis and Miller Household entities, and Amy Miller entity which connects/links the two relationships.

The aerial view pane 530 of the hierarchy manager UI 500 displays a broader topological view of the unified view than is displayed in the graphical view pane 505. The unified view shown in the aerial view pane 530 displays less detail as in the graphical view pane 505 (e.g., does not display text to specify the entities and/or relationships and only displays graphical nodes and connectors) but can display more of the unified view (i.e., display more graphical representations of the entities and relationships) than is displayed in the graphical view pane 505.

In some embodiments, the aerial view pane 530 also indicates the portion of the unified view that is currently displayed in the graphical view pane 505 (e.g., through use of a shaded portion). In the example of FIG. 5A, the entire unified view is shown in shaded portion of the aerial view pane 530 indicating that the entire unified view is currently displayed in the graphical view pane 505. FIG. 5B shows an example screenshot where a portion of the unified view is shown in shaded portion of the aerial view pane 530 indicating that only a portion of the unified view is currently displayed in the graphical view pane 505. FIG. 5C shows an example screenshot where the view of the unified view shown in the aerial view pane 530 and the graphical view pane 505 has been scrolled (from the example screenshot shown in FIG. 5B) using, for example, scrollbars in the aerial view pane 530 or the graphical view pane 505. In some embodiments, user interaction (e.g., scrolling) of the view of the unified view in the aerial view pane 530 produces a corresponding interaction (e.g., scrolling) of the view of the unified view in the graphical view pane 505, and vice versa.

The entity listing pane 540 of the hierarchy manager UI 500 displays a text listing of all entities that are in the unified view of the graphical view pane 505. Rather than searching for a particular entity in the graphical view pane 505, a user may alternatively search the list of entities for the particular entity and select it in the entity listing pane 540. Selecting the particular entity in the entity listing pane 540 also selects the same entity in the graphical view pane 505. Likewise, selection of the particular entity in the graphical view pane 505 will select the same entity in the entity listing pane 540. After selecting a particular entity, the user can then specify, for example, a function to be performed on the entity. FIG. 5D shows an example screenshot where a Julie De Haan entity has been selected in either the graphical view pane 505 or the entity listing pane 540, whereby the corresponding Julie De Haan entity is selected in the entity listing pane 540 or the graphical view pane 505, respectively.

In some embodiments, the graphical view is shown in different layout formats in the graphical view pane 505 depending on a layout request received from the user. FIG. 5E shows an example screenshot of a “Hierarchic” layout format requested by the user and displayed in the graphical view pane 505. FIG. 5F shows an example screenshot of a “Orthogonal” layout format requested by the user and displayed in the graphical view pane 505.

The hierarchy manager implements several pop-up window user interfaces to display corresponding function parameters (such as search or filter parameters) in the hierarchy manager UI. Using methods well known in the art, each pop-up window user interface is configured to be displayed upon receiving a request (e.g., through a pull-down menu, selection of a toolbar item, etc.) for a function corresponding to the pop-up window. Using methods well known in the art, each pop-up window user interface is also configured to receive input from a user to select or specify particular function parameters. Various pop-up window user interfaces corresponding to various functions of the hierarchy manager are shown in the various exemplary screenshots discussed further below.

### III. Searching and Displaying Related Entities Across Multiple Hierarchies Primary Entity Search:

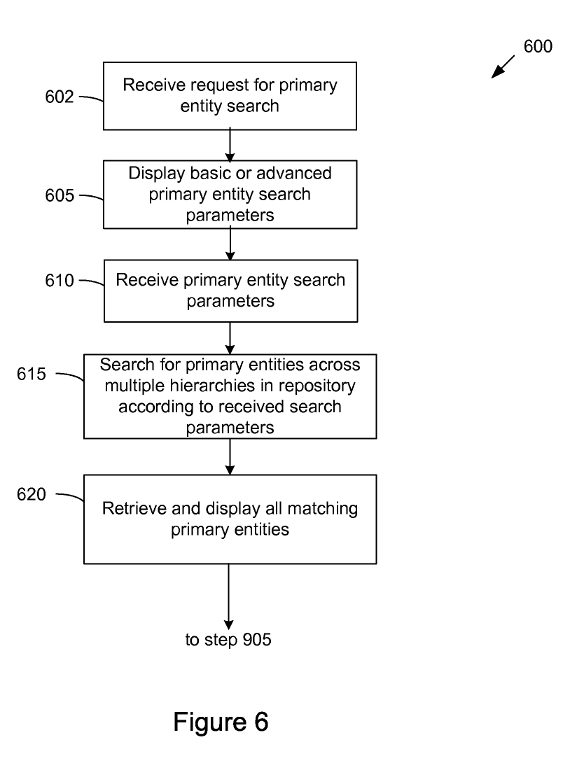

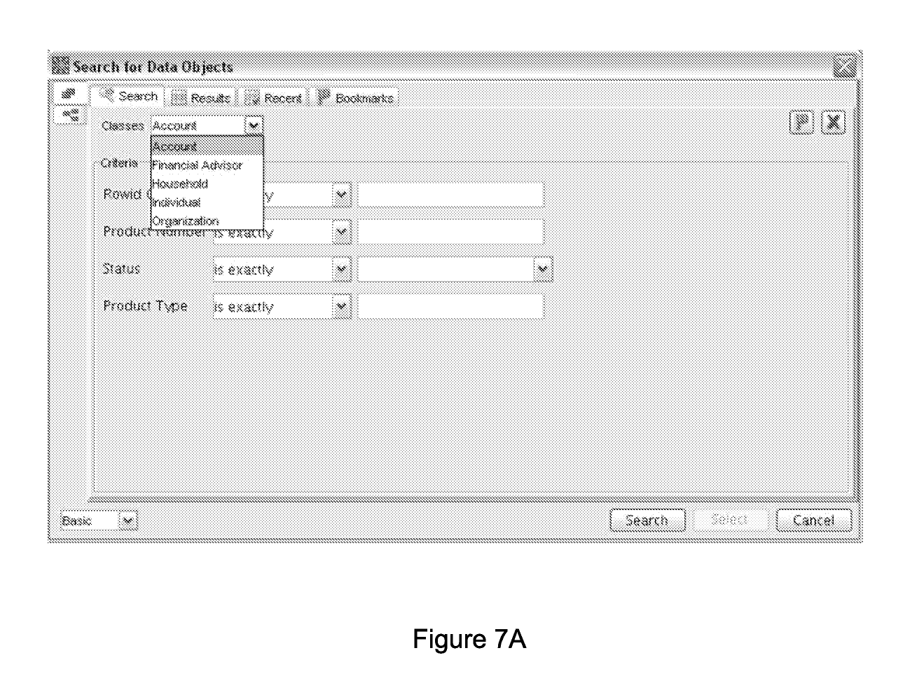

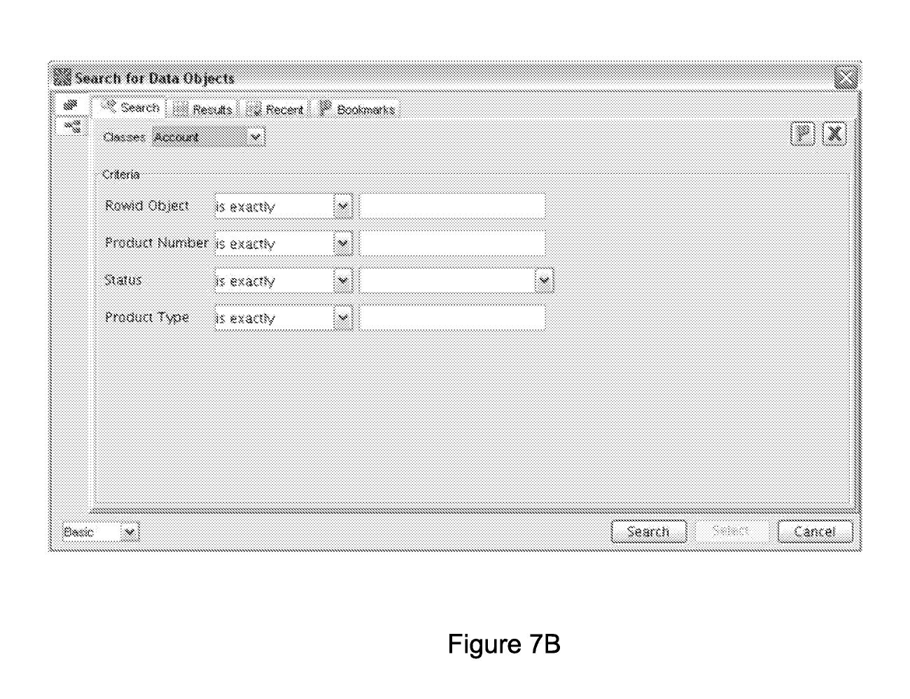

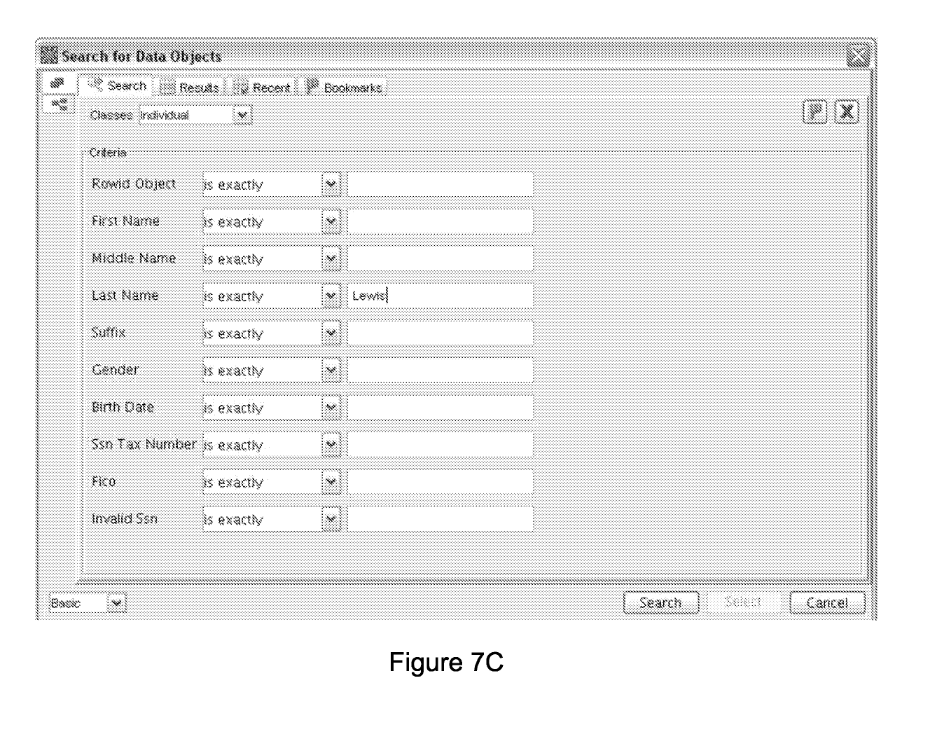

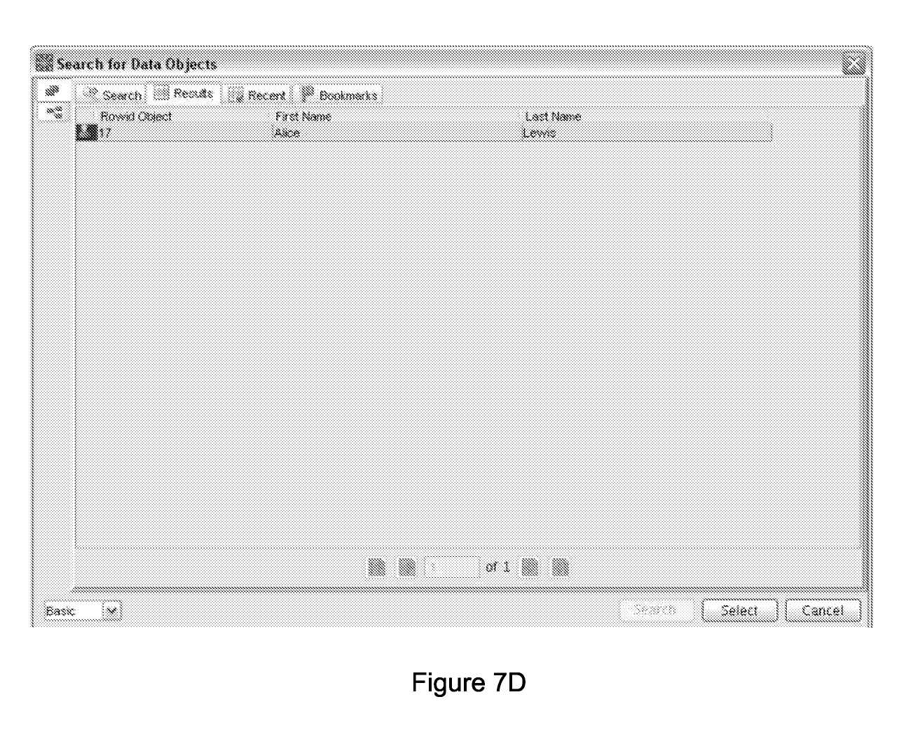

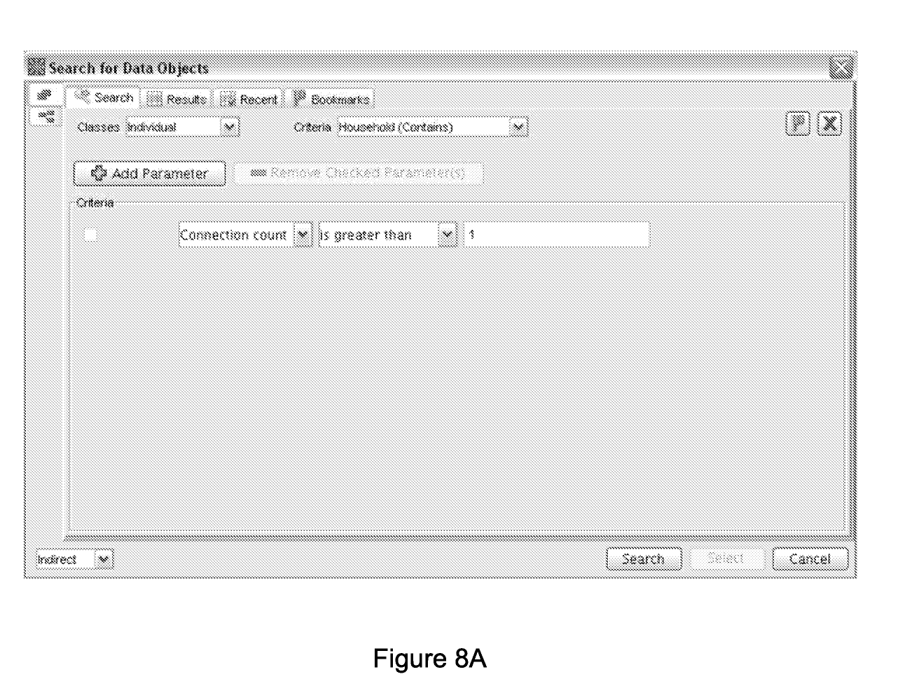

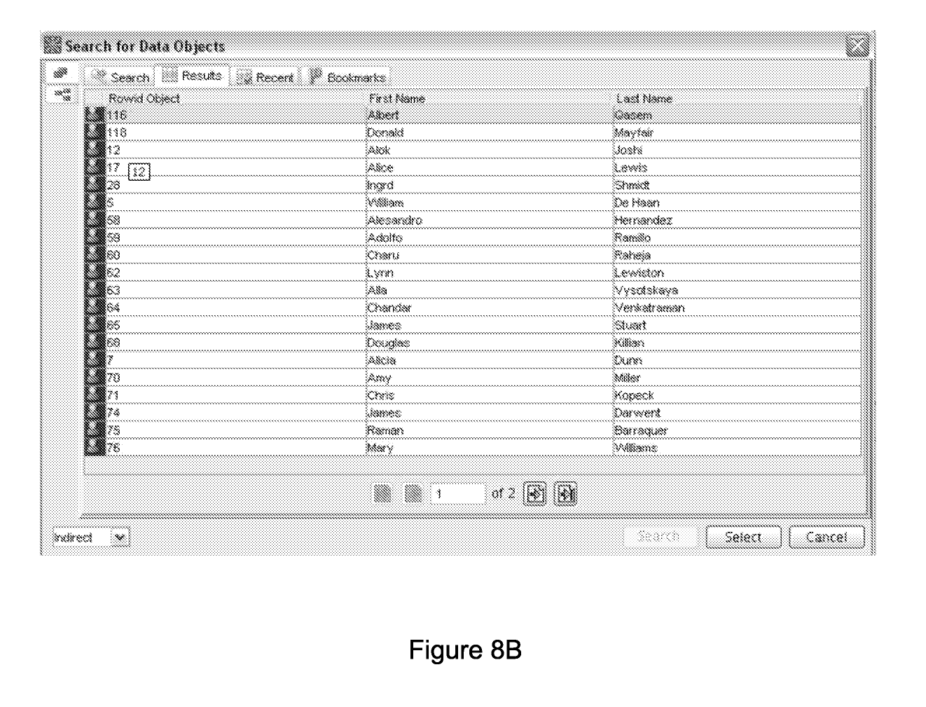

Step 405 of the general method 400 comprises searching for and retrieving a primary entity from across multiple hierarchies in the repository according to received search parameters. FIG. 6 is an exemplary flowchart of a primary entity search method 600 that comprises step 405 of the general method 400. The method 600 is a process that conceptual illustrates a process of interacting with a user interface. The primary entity search method 600 is described in relation to exemplary screen shots shown in FIGS. 7A-D and 8A-B.

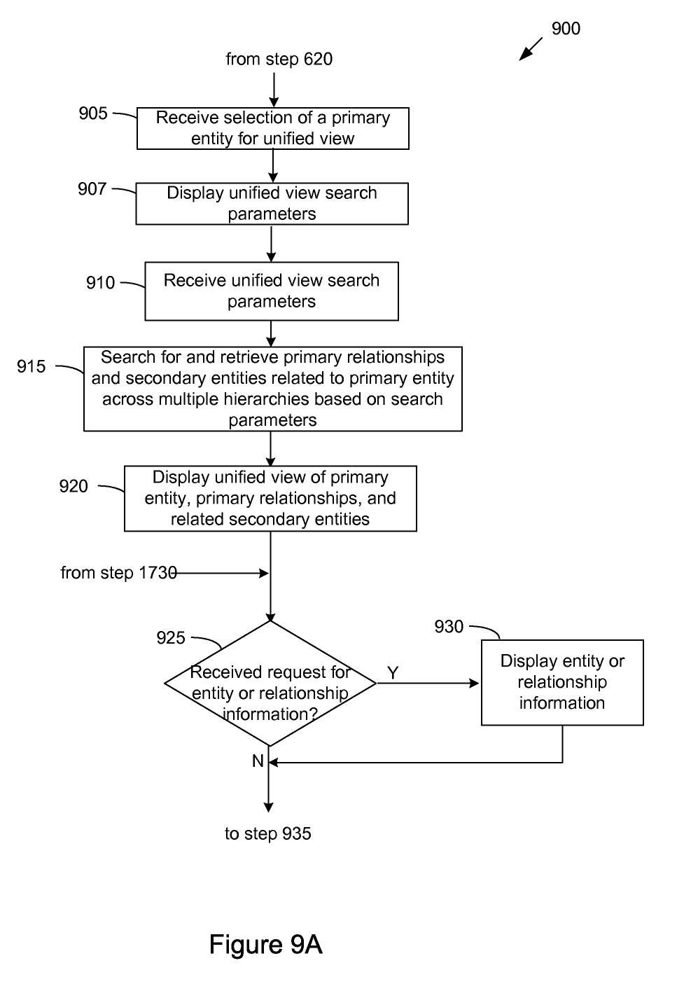

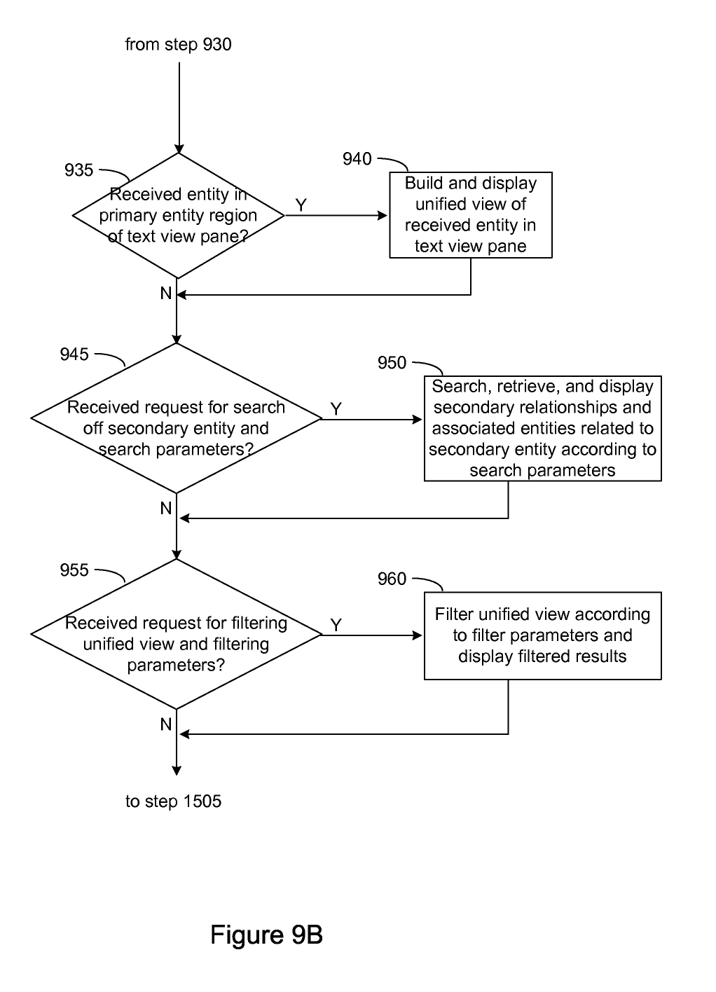

The method 600 begins when it receives (at 602) a request for a primary entity search from a user through the hierarchy manager UI. The method then displays (at 605) primary entity search parameters (e.g., in a pop-up window UI) and receives (at 610) primary entity search parameters from the user. The method 600 searches (at 615) for entities across multiple hierarchies in repository based on the received search parameters. The method then retrieves and displays (at 620) all matching entities. The method then proceeds to step 905 of a unified view build and display method 900 (discussed below in relation to FIGS. 9A-B).

In some embodiments, the method displays (at 605) basic primary entity search parameters, as shown in the exemplary screenshots FIGS. 7A-D. As shown in FIG. 7A, a basic search parameter includes entity class type (e.g., Account, Individual, etc.) where further search parameters vary depending on the entity class type selected. As shown in FIG. 7B, selection of the Account class type provides a set of further search parameters, such as Rowid Object (the identifier/name of a data source/hierarchy in coded form), Product Number, Status, etc. As shown in FIG. 7C, selection of the Individual class type provides a different set of further search parameters, such as Rowid Object, Name, Suffix, Gender, etc. FIG. 7D shows results of a search and retrieval operation based on the search parameters shown in FIG. 7C where, whereby one matching entity (Alice Lewis) is found in the repository.

In some embodiments, the method displays (at 605) advanced primary entity search parameters, as shown in the exemplary screenshots FIGS. 8A-B. As shown in FIG. 8A, an advanced search parameter includes criteria for relationship types (e.g., Household Contains) to search for entities having a certain relationship type. Another advanced search parameter includes criteria for connection counts to search for entities having a certain number of a particular relationship type. In the example of FIG. 8A, the advanced search parameters specify a search for Individual type entities having more than one Household Contains relationship. FIG. 8B shows results of the search and retrieval for matching entities in the repository where multiple matching entities were found.

### Build and Display Unified View of Primary Entity:

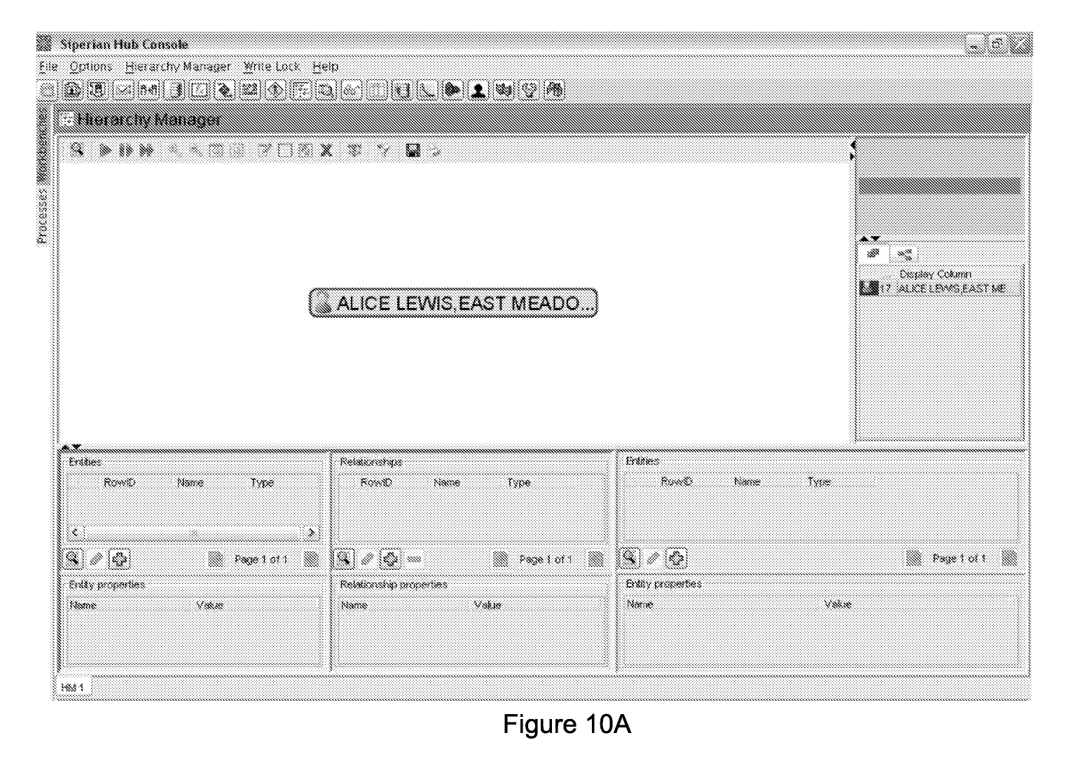

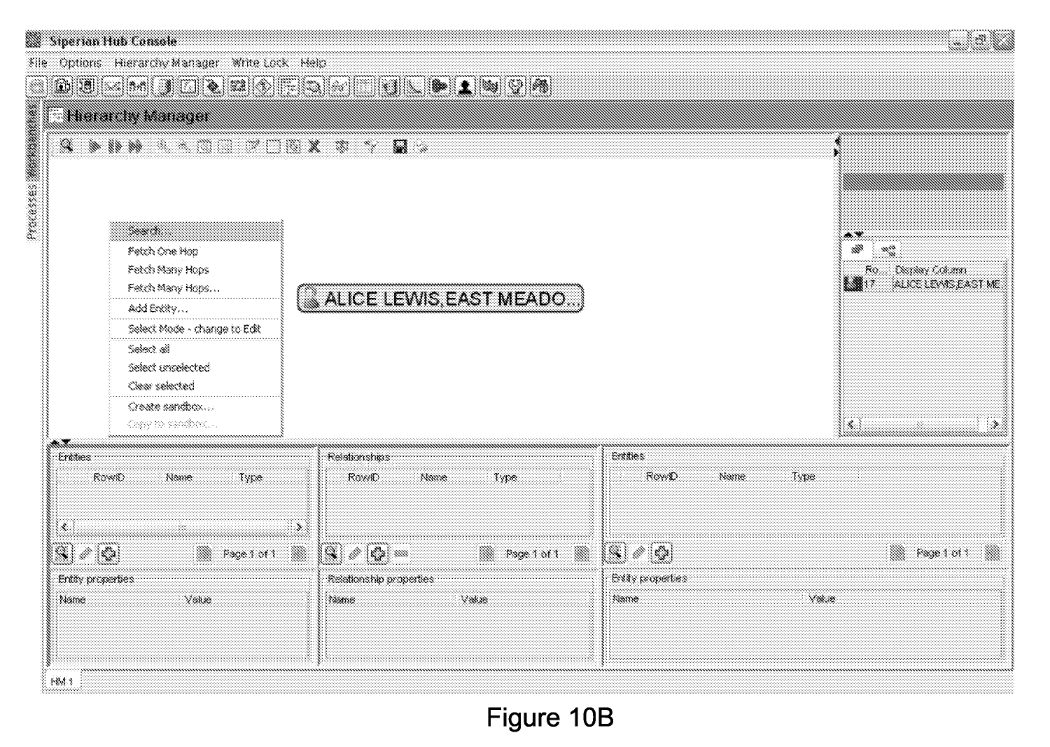

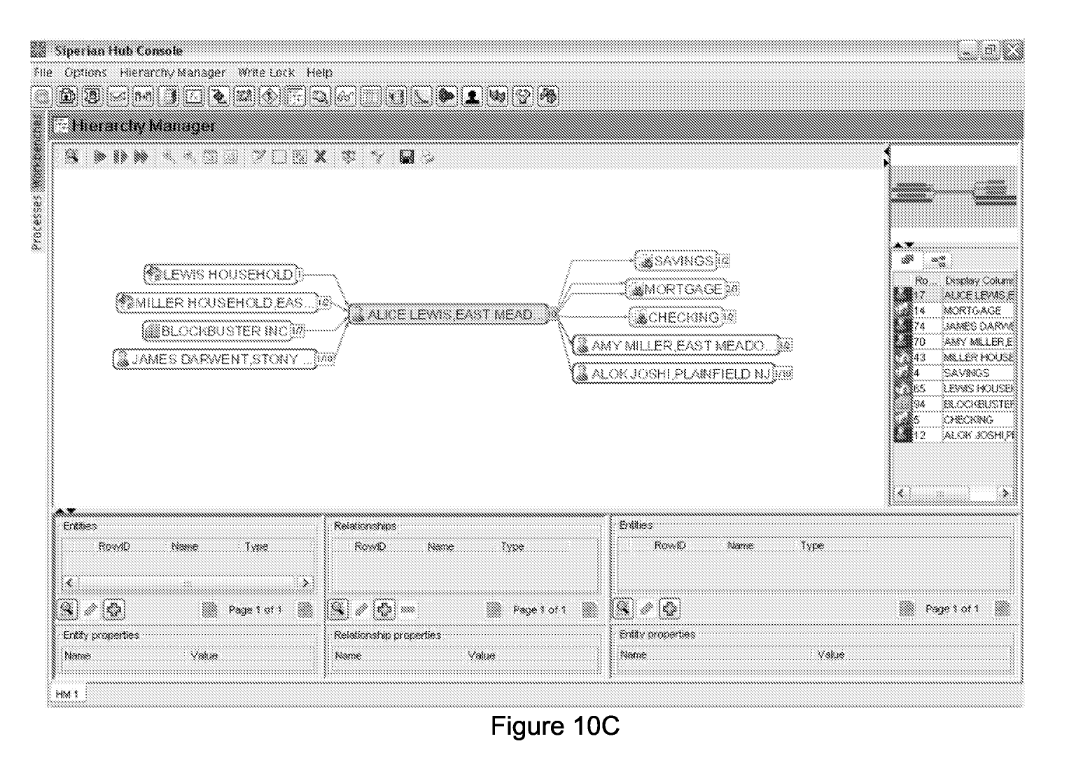

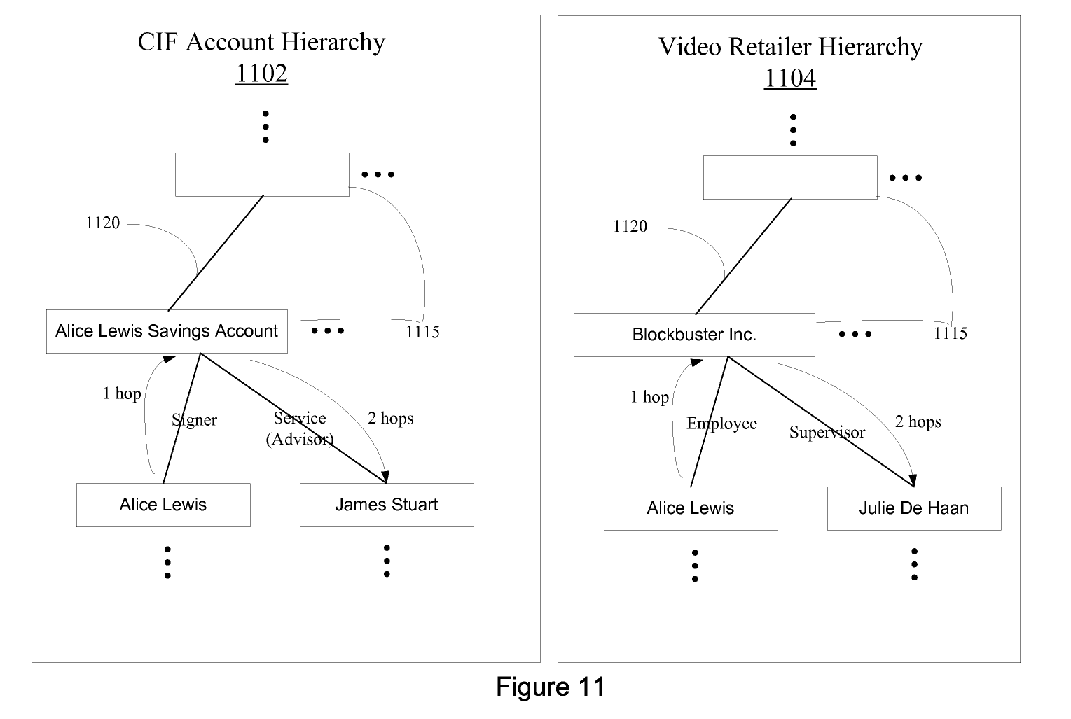

FIGS. 9A-B are flowcharts of a unified view build and display method 900 that comprises steps 410 through 425 of the general method 400. The method 900 is a process that conceptual illustrates a process of interacting with a user interface. The unified view build and display method 900 is described in relation to FIG. 11 and exemplary screenshots shown in FIGS. 10A-C, 12A-B, 13A-C, and 14A-B.

The method 900 proceeds from step 620 of the primary entity search method 600 of FIG. 6 and begins when it receives (at 905) a selection of a primary entity for a unified view from a user through the hierarchy manager UI. The method then displays (at 907) unified view search parameters (e.g., in a pop-up window UI) that specify search parameters for relationships of the primary entity (primary relationships) and/or for entities related to the primary entity (secondary entities) and receives (at 910) unified view search parameters from the user. The method 900 searches for and retrieves (at 915) primary relationships and secondary entities in each hierarchy of the repository based on the received search parameters. The method then imports and displays (at 920) the primary entity, primary relationships, and related secondary entities in a unified view.

The exemplary screenshot of FIG. 10A shows an example where the Alice Lewis entity is selected as a primary entity for a unified view, for example, by selecting the entity from the search results (as shown in FIGS. 7D and 8D) of a primary entity search. The exemplary screenshot of FIG. 10B shows an example where the displayed unified view search parameters include “Fetch One Hop” (direct relationship search and retrieval) and “Fetch Many Hops” (indirect relationship search and retrieval). As discussed above in relation to FIG. 2, two entities may have a direct relationship (“one-hop” relationship) when no intermediary entity is needed to establish a connection/relationship between the two entities or an indirect relationship (“multi-hop” relationship) when one or more intermediary entities are needed to establish a connection/relationship between the two entities.

FIG. 11 shows a conceptual diagram of a exemplary search for direct or indirect relationships to a primary entity across two data hierarchies 1102 and 1104. As shown in FIG. 11, a CIF Account hierarchy 1102 and a Video Retailer hierarchy 1104 comprise a plurality of entities 1115 and relationships 1120 between the entities 1110. In the example of FIG. 11, an Alice Lewis entity is the primary entity that is the basis of the repository search for primary relationships and secondary entities.

If the unified view search parameters (received at step 910) specify a one hop search off the primary entity, the method 400 searches for and retrieves (at step 915) direct relationships of the primary entity and the secondary entities associated with these direct relationships from the CIF Account hierarchy 1102 and the Video Retailer hierarchy 1104. For example, in the CIF Account hierarchy 1102, the method would first locate the Alice Lewis primary entity, then locate the Signer relationship (which is a direct “one-hop” relationship) and the Alice Lewis Savings Account entity that is associated with the Signer relationship, and then retrieve the Signer relationship and the Alice Lewis Savings Account entity. As a further example, in the Video Retailer hierarchy 1104, the method would first locate the Alice Lewis primary entity, then locate the Employee relationship (which is a direct “one-hop” relationship) and the Blockbuster secondary entity that is associated with the Employee relationship, and then retrieve the Employee relationship and the Blockbuster secondary entity.

If the unified view search parameters (received at step 910) specify a two-hop search off the primary entity, the method 400 searches for and retrieves (at step 915) direct relationships of the primary entity, as discussed above. Further, the method 400 searches for and retrieves indirect “two-hop” relationships of the primary entity (i.e., where one intermediary entity is needed to establish a connection between the primary entity and the relationship) and the secondary entities associated with these indirect relationships from the CIF Account hierarchy 1102 and the Video Retailer hierarchy 1104. For example, in the CIF Account hierarchy 1102, the method would also locate the Service relationship (which is an indirect “two-hop” relationship) and the James Stuart entity this is associated with the Service relationship, and retrieve the Service relationship and the James Stuart entity. In the Video Retailer hierarchy 1104, the method would also locate the Supervisor relationship (which is an indirect “two-hop” relationship) and the Julie De Haan entity that is associated with the Supervisor relationship, and retrieve the Supervisor relationship and the Julie De Haan entity.

The screenshot of FIG. 10C shows an example of a unified view (displayed at step 920) of the Alice Lewis primary entity, primary relationships, and related secondary entities that are the results of a one-hop search and retrieval operation. Note that the direct relationships between the primary entity Alice Lewis and the secondary entities Blockbuster and Alice Lewis Savings Account (abbreviated as “Savings”) are shown in the unified view, where the Blockbuster and Savings secondary entities originate from different data hierarchies/data sources (as shown in FIG. 11).

In some embodiments, a unified view displays/indicates at least one indirect “cross” relationship between first and second entities through at least one other entity that connects/links the first and second entities and establishes the “cross” relationship between the first and second entities, the first and second entities originating from two different hierarchies. In some embodiments, the two hierarchies originate from two different data sources. A comprehensive and unified view of related entities across multiple hierarchies (as provided in some embodiments herein) allows such “cross” relationships to be indicated, whereas non-comprehensive independent views of single hierarchies do not.

For example, in FIG. 10C, the unified view displays/indicates an indirect “cross” relationship between the Blockbuster and Savings secondary entities through the Alice Lewis primary entity that establishes the “cross” relationship between the two secondary entities. Note that in FIG. 10C, this “cross” relationship is indicated by the connector representation of the relationship between the Blockbuster and Alice Lewis entities, the node representation of the Alice Lewis, and the connector representation of the relationship between the Alice Lewis and Savings entities.

As shown in the example of FIG. 5A, various entities are represented as rectangle shaped nodes having text that identifies the represented entity. Also, relationships are shown as arrowed lines connecting two related entities. In other embodiments, the entities and relationships are represented by other polygons or graphical forms. In the example shown in FIG. 5A, the unified view displayed in the graphical view pane 505 comprises an Alice Lewis entity is a primary entity (displayed in the middle) with various related secondary entities (e.g., Blockbuster, Savings, Mortgage, etc.) displayed around the Alice Lewis primary entity.

In the example of FIG. 10C, the unified view is displayed as a graph in the graphical view pane 505, the graph having node representations of various entities (each node having text that specifies the entity it represents) and connector representations of the various relationships between the entities. In some embodiments, each node representation of a particular entity also includes text that specifies a relationship ratio (e.g., 1/2, 2/3, 1/10, etc.). The denominator of the relationship ratio indicates the number of direct relationships to the particular entity in the repository that are also related to the primary entity. The numerator of the relationship ratio indicates the number of these direct relationships that are currently displayed in the graph. For example, in FIG. 10C, the relationship ratio of 1/2 displayed in the node representation of the Savings entity to indicate that there are 2 direct relationships to the Savings entity in the repository that are also related to the Alice Lewis primary entity and that only 1 of these direct relationships is currently displayed in the graph. If desired, a one-hop or multi-hop search can then be performed off the Savings secondary entity to retrieve and display the other remaining direct relationship (as discussed below).

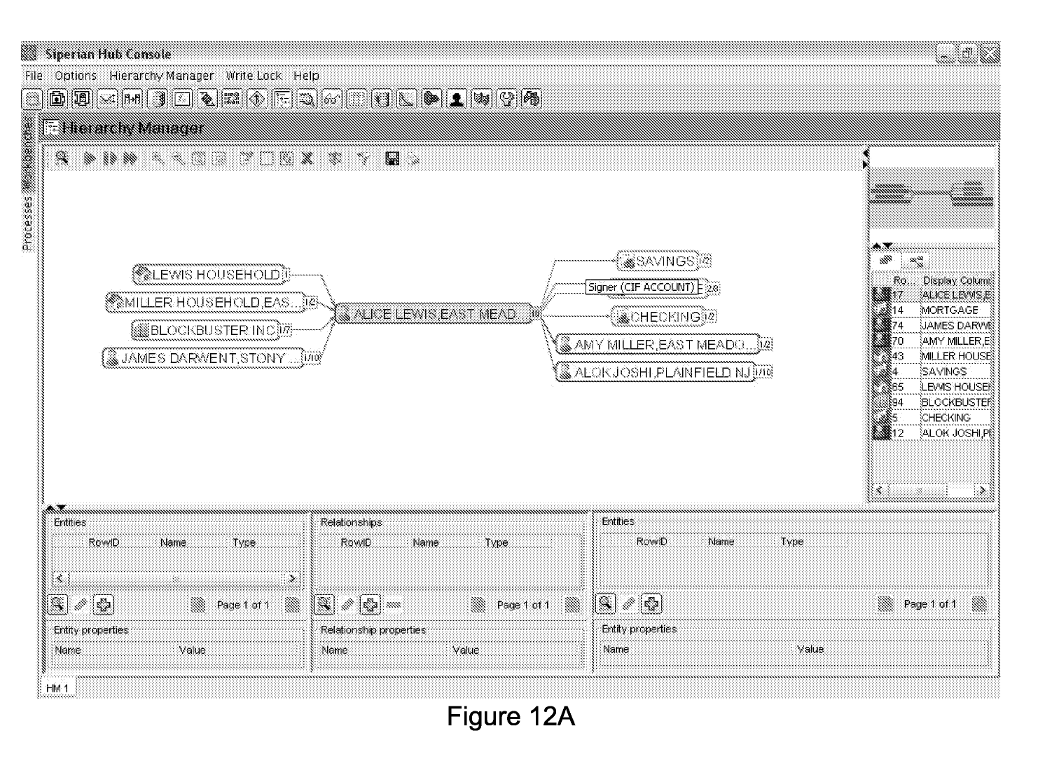

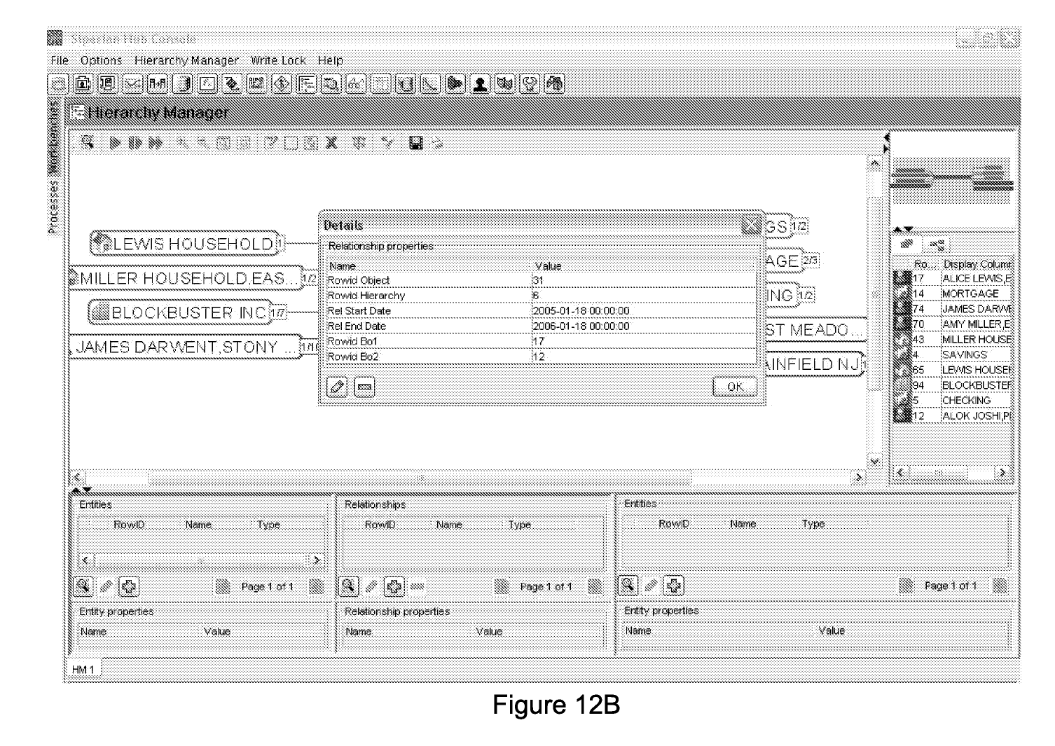

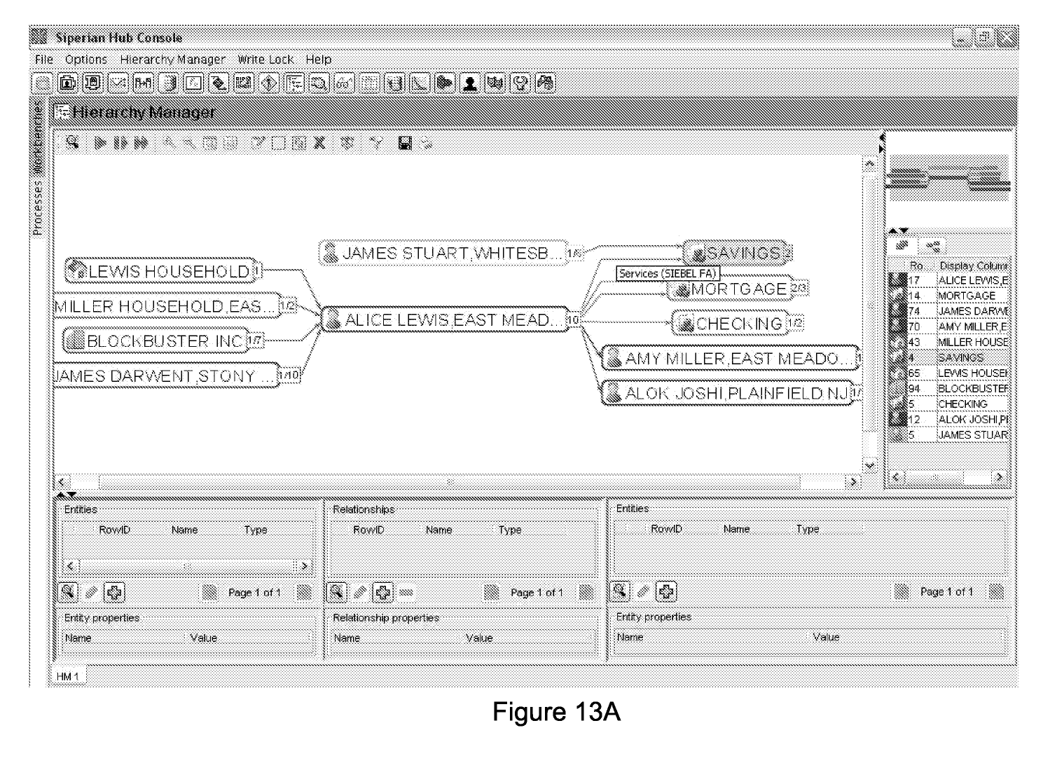

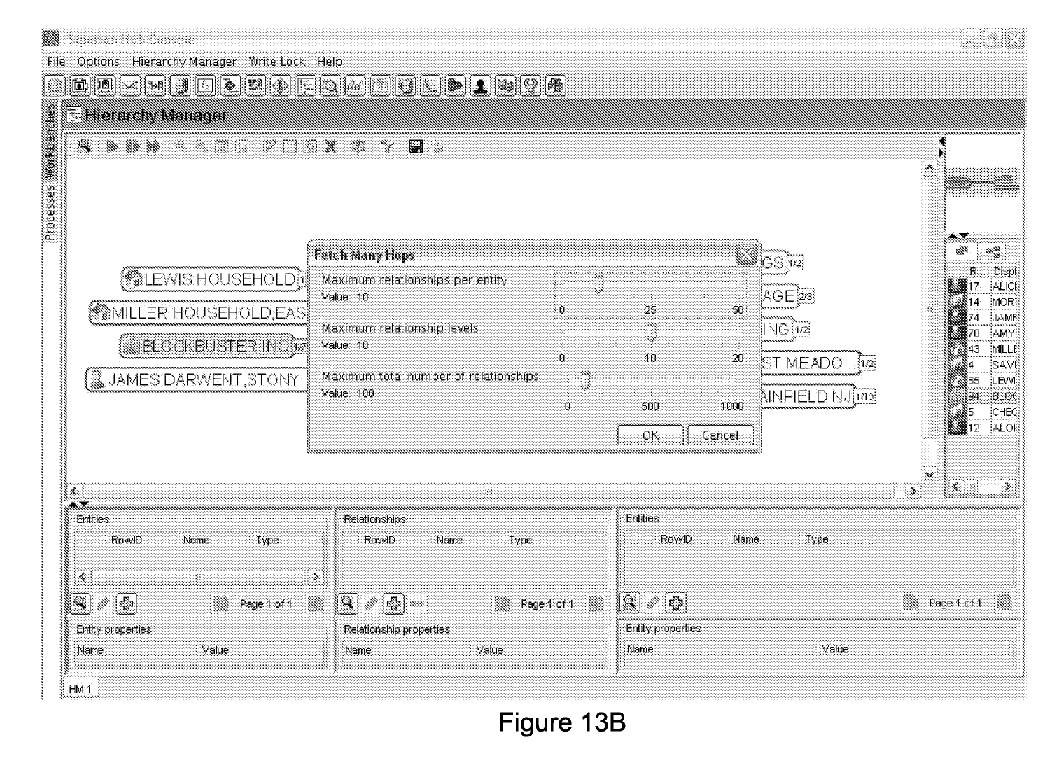

After displaying the unified view (at 920), the method then determines (at 925) if a request for information regarding a specific entity or relationship is received from a user through the hierarchy manager UI. If so, the method displays (at 930) the requested entity or relationship information. In some embodiments, entity or relationship information is shown in a pop-up window when, for example, the user floats a cursor (controlled by a cursor-controller) in the hierarchy manager UI over a node representation of an entity or a connector representation of a relationship in the graph. The screenshot of FIG. 12A shows an example of entity and relationship information that is displayed in pop-up window when the cursor is floated over a secondary entity (e.g., the Savings entity), the information comprising the type of relationship (e.g., Signer) between the secondary entity and the primary entity and the hierarchy or data source (e.g., CIF Account) from which the secondary entity originates. In other embodiments, the pop-up window is customizable to display other types of entity or relationship information. In some embodiments, other more detailed entity or relationship information is requested and displayed. The screenshot of FIG. 12B shows an example of greater detailed information for a selected relationship being shown in a pop-up window.

After step 930, the method then determines (at 935) if an entity has been received in the primary entity region 512 of the text view pane 510. If so, the method builds and displays and displays (at 940) a unified view of the received entity in the text view pane 510. As discussed above in relation to FIG. 5A, an entity can be received in the primary entity region 512 as a primary entity where the hierarchy manager then automatically builds (i.e., searches for and retrieves primary relationships and secondary entities) and displays a unified view of the primary entity in the text view pane 510.

After step 940, the method then determines (at 945) if a request for a search off a secondary entity and parameters for the search are received. If so, the method 900 searches for and retrieves (at 950) the relationships of the secondary entity (secondary relationships) and entities related to the secondary entity (associated entities) from across multiple hierarchies in the repository according to the received search parameters (for example, that specify a one-hop or multi-hop search). The method 900 also displays (at 950) the search results.

In the exemplary screenshot of FIG. 13A, results for a one-hop search and retrieval request off the Savings secondary entity are displayed, whereby the James Stuart entity is located and retrieved. As shown in the example of FIG. 13A, the James Stuart entity has a Services relationship with the Savings entity and originates from the Siebel FA hierarchy/data source. In FIG. 13A, the relationship ratio next to the Savings entity is now 2 (and no longer 1/2) since the remaining direct relationship to the Savings entity that is also related to the Alice Lewis primary entity (the Services relationship with the James Stuart entity) is now displayed.

The unified view of FIG. 13A also shows/indicates several indirect cross relationship between various entities. For example, a cross relationship is shown between the James Stuart entity and the Amy Miller entity through the Savings and Alice Lewis entities, the James Stuart and the Amy Miller entities originating from different hierarchies/data sources. Such cross relationships can be used by the user to identify potential opportunities or clients. For example, the unified view of FIG. 13A may indicate that James Stuart is the financial advisor for Alice Lewis on her Savings account (thus the “Services” relationship type) and that Amy Miller is the daughter of Alice Lewis. As such, James Stuart can contact Alice Lewis about whether her daughter Amy Miller would like to sign up for a savings account as well, or contact Amy Miller directly. Since the unified view indicates the cross relationship between the James Stuart entity and the Amy Miller entity, this opportunity can be identified by the user. On the other hand, non-comprehensive independent views of single hierarchies do not indicate such cross relationships and makes it difficult for a user to identify such opportunities or clients.

The exemplary screenshot of FIG. 13B shows a pop-up window UI for specifying search parameters for a multi-hop search off the Blockbuster secondary entity, the pop-up window UI appearing after a request for a multi-hop search is received. In the example of FIG. 13B, search parameters for a multi-hop search off the Blockbuster secondary entity include a maximum number of relationships per entity, a maximum number of relationship levels (i.e., the maximum number of hops that are needed to connect a secondary entity to the primary entity), and a maximum total number of relationships to be retrieved. The exemplary screenshot of FIG. 13C shows results for the multi-hop search request specified in FIG. 13B, whereby a multitude of secondary relationships and associated entities are retrieved and displayed. In FIG. 13C, the relationship ratio next to the Blockbuster entity is now 7 (and no longer 1/7, as shown in FIG. 13A) since the remaining direct relationships to the Blockbuster entity that are also related to the Alice Lewis primary entity are now displayed.

After step 950, the method then determines (at 955) if a request for filtering the unified view and filtering parameters are received. If so, the method 900 filters (at 960) the unified view according to received filter parameters and displays the filter results. In the exemplary screenshot of FIG. 14A, a filter window user interface displays filter parameters whereby filter parameters are set for the Blockbuster entity of the unified view shown in FIG. 13C. As shown in FIG. 14A, entities and relationships in the unified view can be filtered out based on filter parameters shown in the filter window interface, such as hierarchy identifier/name, relationship types, relationship directions, etc. The exemplary screenshot of FIG. 14B shows results of a filtering operation based on the received filter parameters shown in FIG. 14A. As shown in FIG. 14B, the entities and relationships in the unified view of FIG. 13C have been filtered such that only the entities having a “Works for/Employees” relationship with the Blockbuster entity is displayed. One of ordinary skill in the art will realize that the filtering function (of steps 955 and 960) are independent of and may be performed separate from the search and/or other functions described herein. In these embodiments, the filter window user interface (shown in FIG. 14A) is used to display and receive filter parameters as described above.

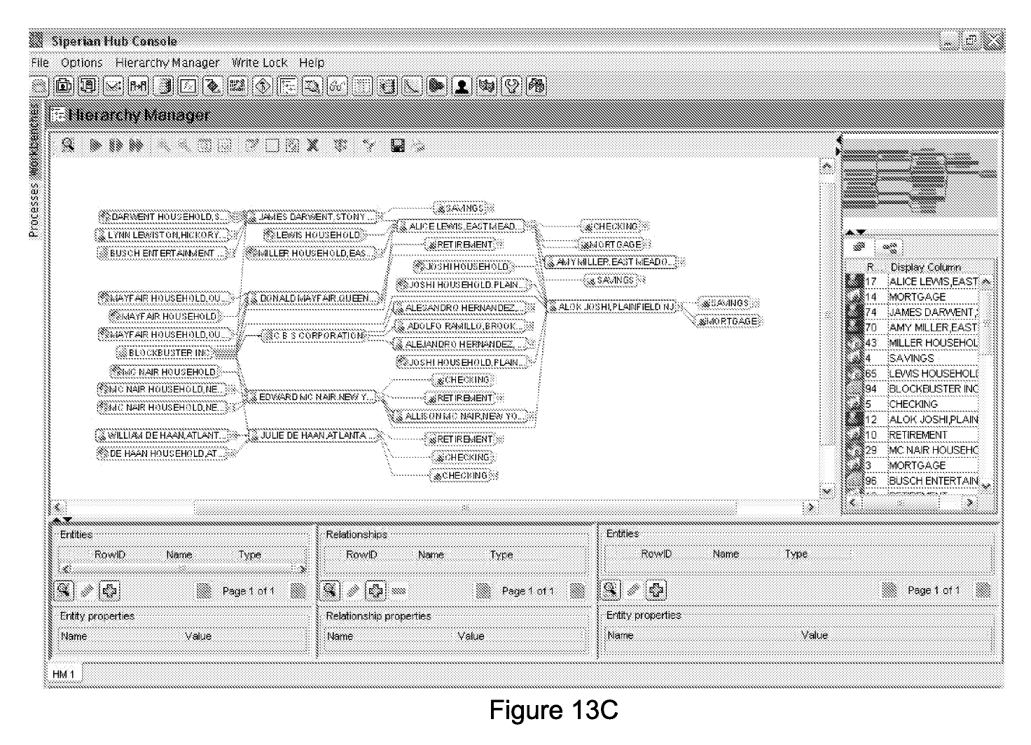

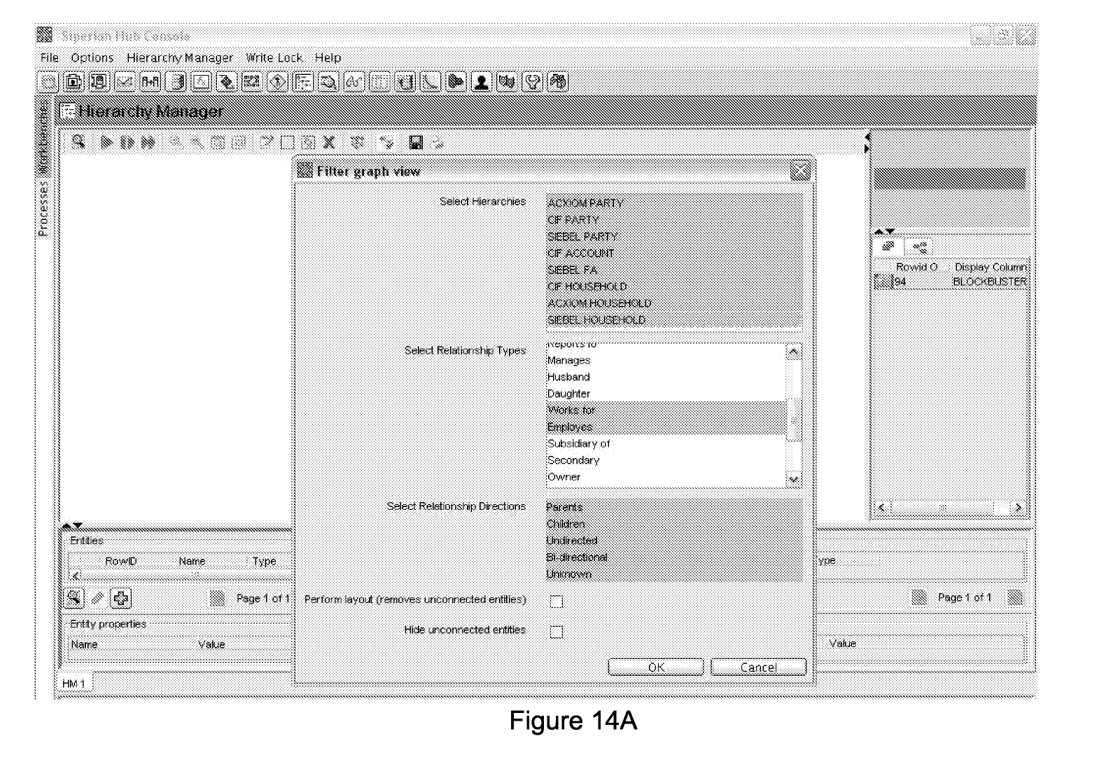

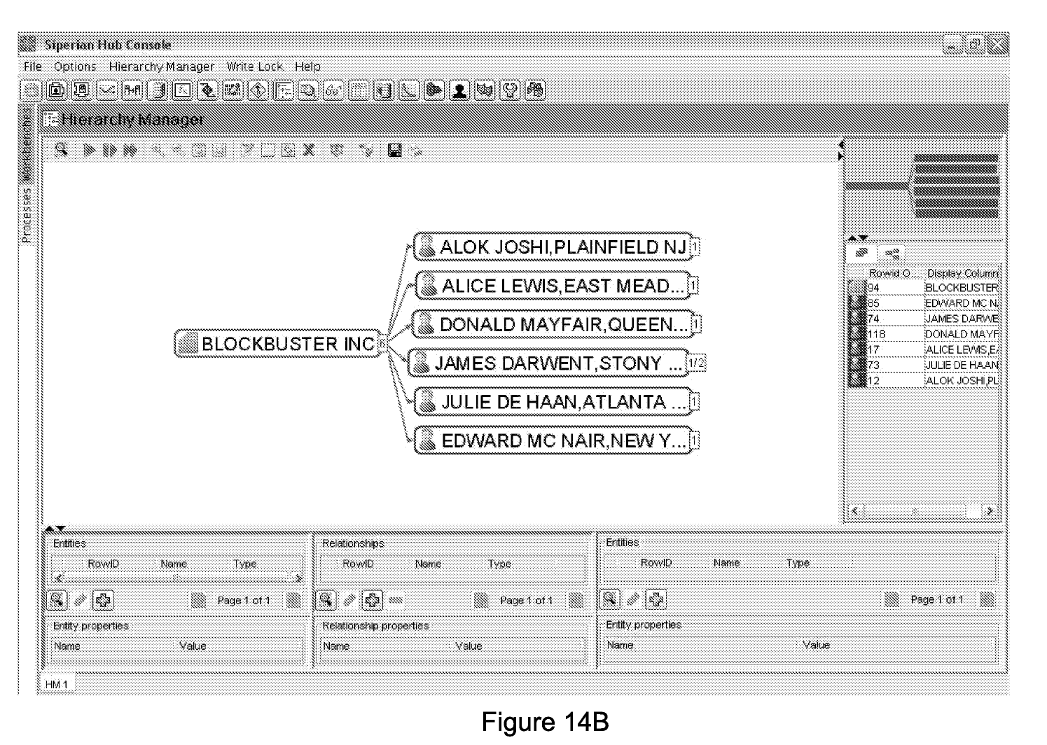

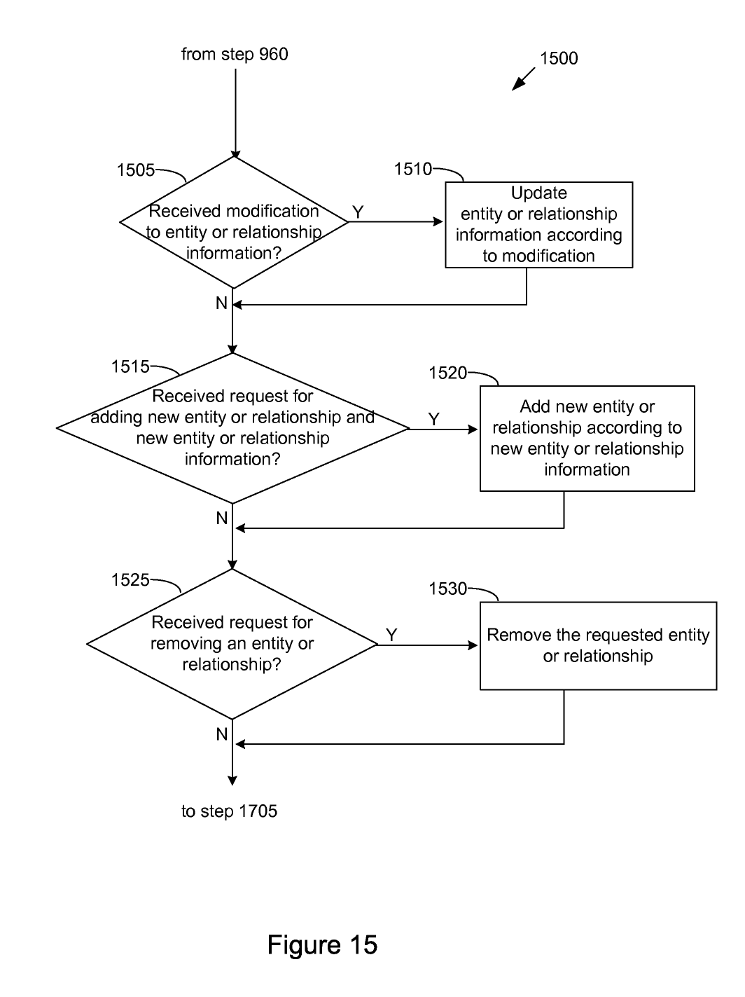

After step 960, the method then proceeds to step 1505 of an update method 1500 (discussed below in relation to FIG. 15).

### IV. Updating Entities and Relationships in the Unified View

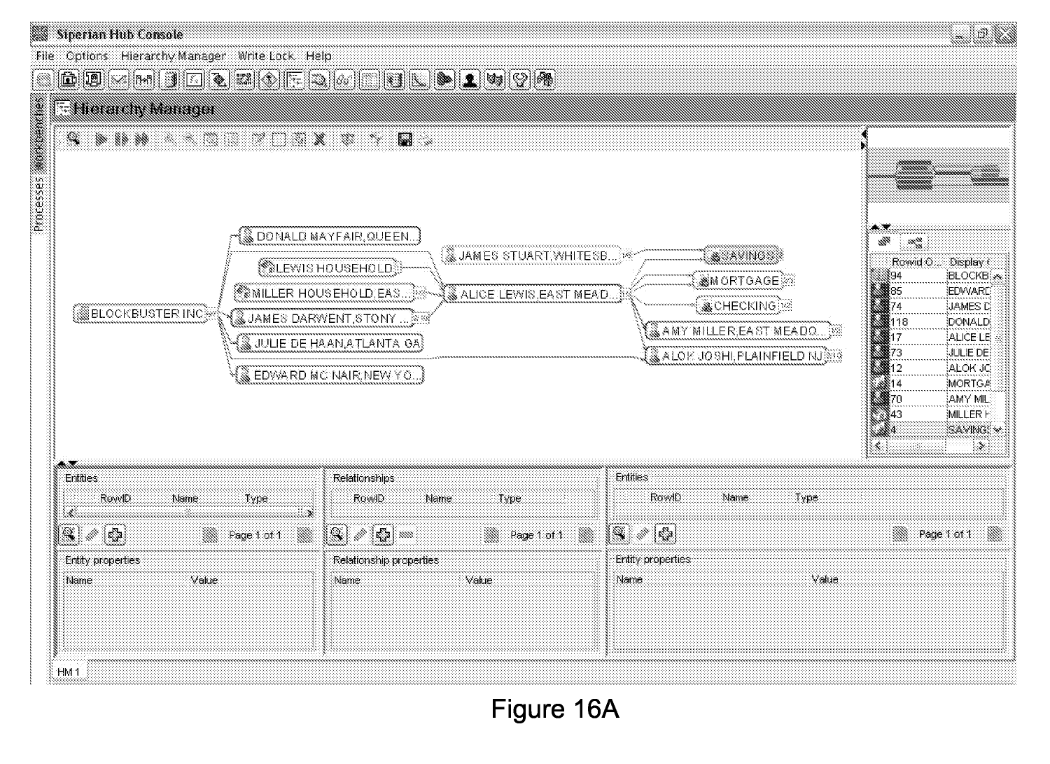

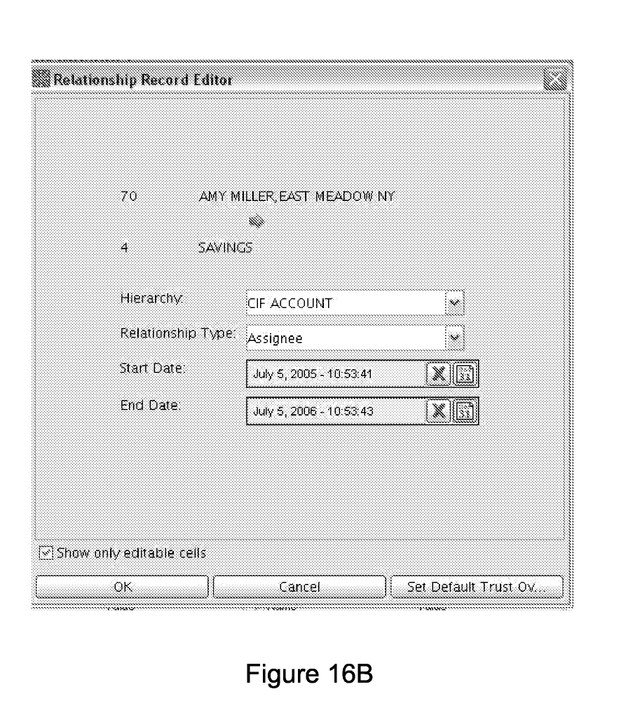

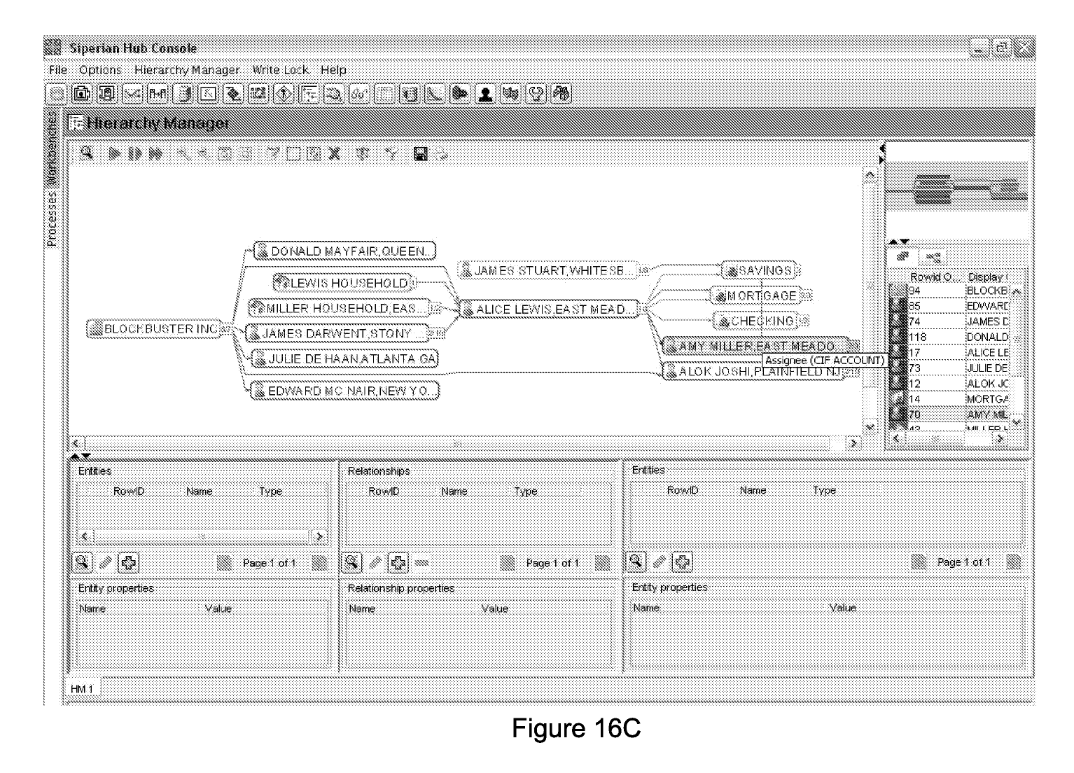

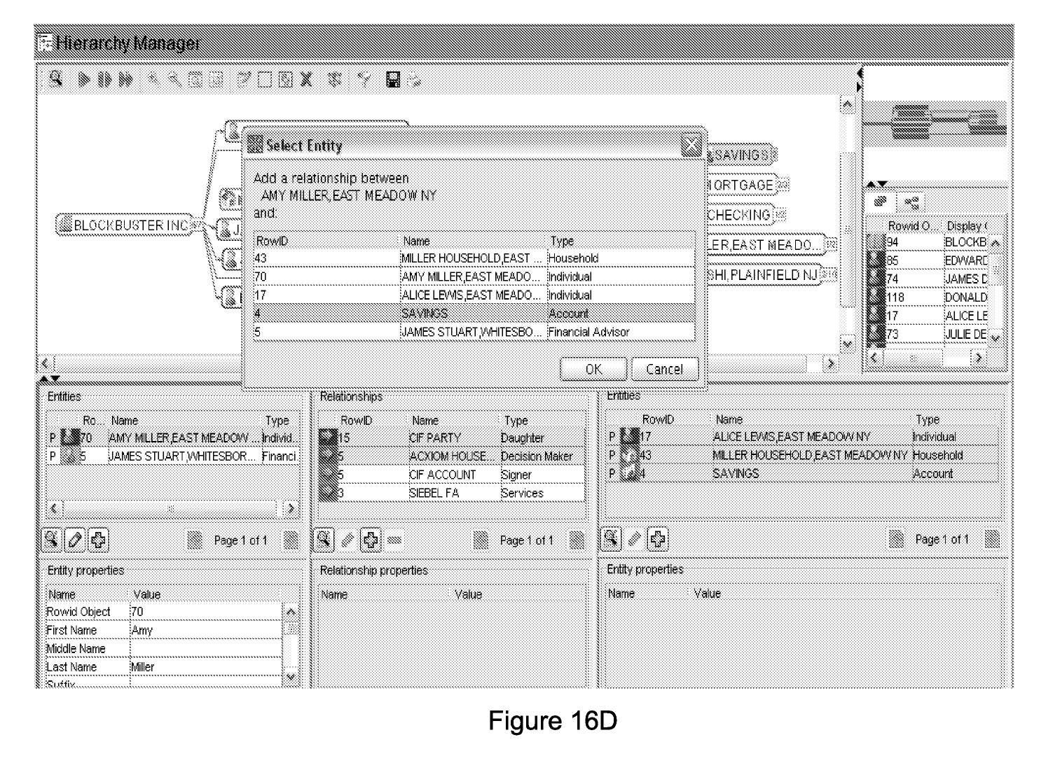

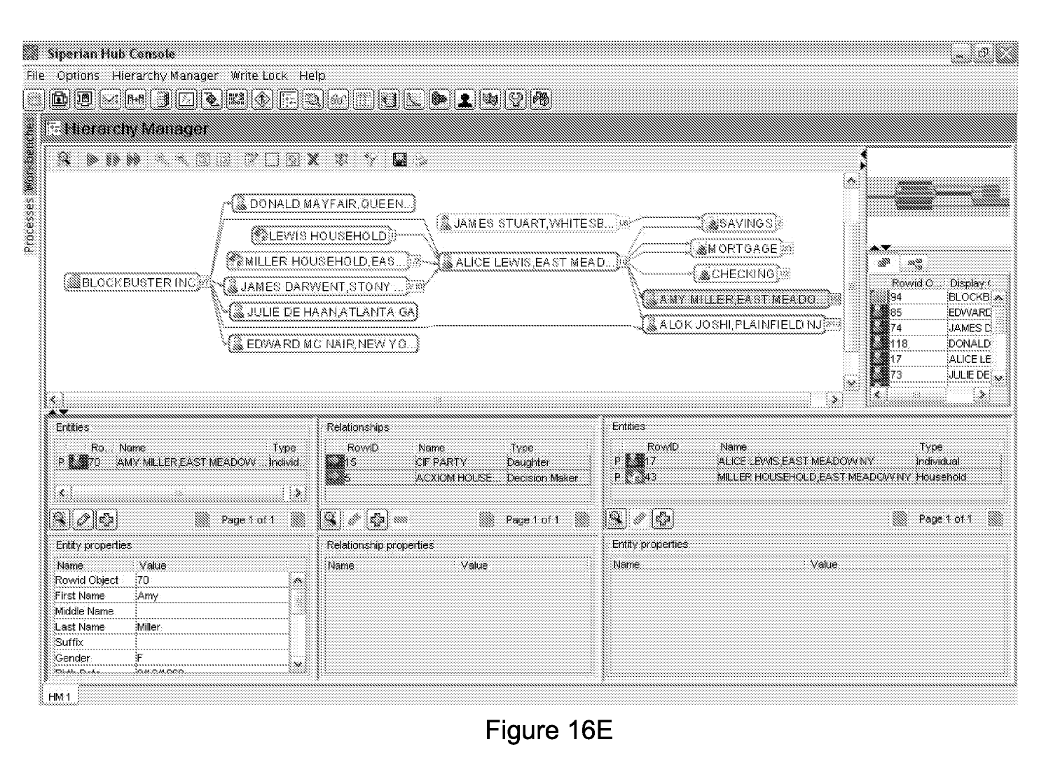

As updated information regarding entities or relationships in the repository is made known or available to the user, the hierarchy manager allows the user to modify, add, or remove information regarding such entities or relationships using the unified view. FIG. 15 is a flowchart of an update method 1500 that comprises step 430 of the general method 400. The method 1500 is a process that conceptual illustrates a process of interacting with a user interface. The update method 1500 updates one or more entities or relationships in the unified view according to received updated data that modifies, adds, or removes an entity or relationship. The update method 1500 is described in relation to exemplary screenshots shown in FIGS. 16A-E.

The method 1500 proceeds from step 960 of the unified view build and display method 900 and begins by determining (at 1505) if a modification to information for an entity or relationship is received. If so, the method 1500 replaces (at 1510) the older corresponding information for the entity or relationship with the received information.

The method 1500 then determines (at 1515) if a request for adding a new entity or relationship and new entity or relationship information has been received. If so, the method 1500 adds (at 1520) the new entity or relationship according to the received new entity or relationship information. The new entity or relationship can be added through the graphical view pane 505 (e.g., by dragging a first entity representation and dropping it onto a second entity representation in the graphical view pane 505) or the text view pane 510 of the hierarchy manager (e.g., by dragging an entity representation from the graphical view pane 505 into the secondary entity region 520 of the text view pane 510). In some embodiments, a new relationship is created between first and second entities of the unified view, the first and second entities originating from two different hierarchies/data sources.

The exemplary screenshot of FIG. 16A shows an initial unified view shown in the graphical view pane 505. The exemplary screenshot of FIG. 16B shows a pop-up window UI for adding a new relationship and entering information regarding the new relationship, the pop-up window UI appearing after the Amy Miller entity is dragged and dropped onto the Savings entity in the graphical view pane 505. In the example of FIG. 16B, an Assignee relationship is being added between the Amy Miller entity and the Savings entity in the unified view. The exemplary screenshot of FIG. 16C shows the results of the relationship adding operation specified in FIG. 16B. As shown in FIG. 16C, the Amy Miller and Savings entities are now shown to be related.

The exemplary screenshot of FIG. 16D shows a pop-up window UI for adding a new relationship and entering information regarding the new relationship, the pop-up window UI appearing after the Savings entity in the graphical view pane 505 is dragged and dropped onto the secondary entity region 520 of the text view pane 510 while the Amy Miller entity is a primary entity in the primary entity region 512. Recall that the secondary entity region 520 contains entities related to the primary entity contained in the primary entity region 512. As such, dropping an entity into the secondary entity region 520 adds a relationship to the primary entity in the primary entity region 512. In the example of FIG. 16D, an Account relationship is being added between the Amy Miller entity and the Savings entity in the unified view.

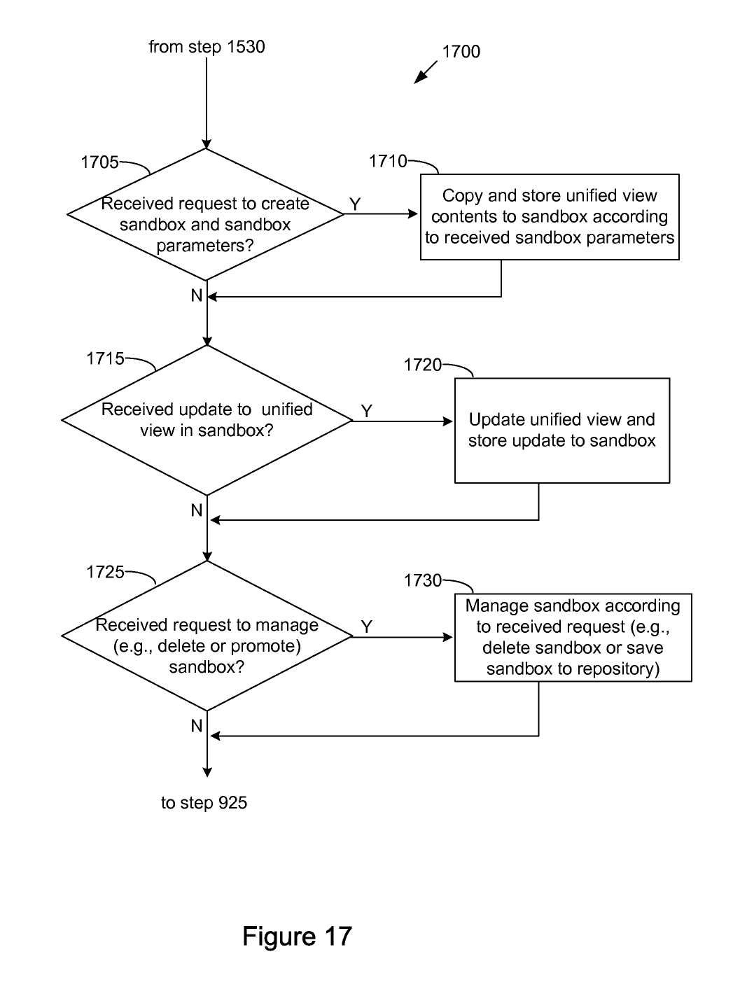

After step 1520, the method 1500 then determines (at 1525) if a request for removing an entity or relationship has been received. If so, the method 1500 removes (at 1530) the entity or relationship. The new entity or relationship can be removed through the graphical view pane 505 or the text view pane 510 of the hierarchy manager. The exemplary screenshot of FIG. 16E shows the unified view shown in FIG. 16C with the newly added relationship (the Assignee relationship between the Amy Miller and Savings entities) being removed. After step 1530, the method then proceeds to step 1705 of a sandbox method 1700 (discussed below in relation to FIG. 17).

In some embodiments, the above described updated information received through the hierarchy manager is stored to the repository and/or replaces the older corresponding information in the repository that it supplants. In other embodiments, the new or modified information is initially copied and stored to a “sandbox” storage area.

### V. Storing a Unified View to a Sandbox

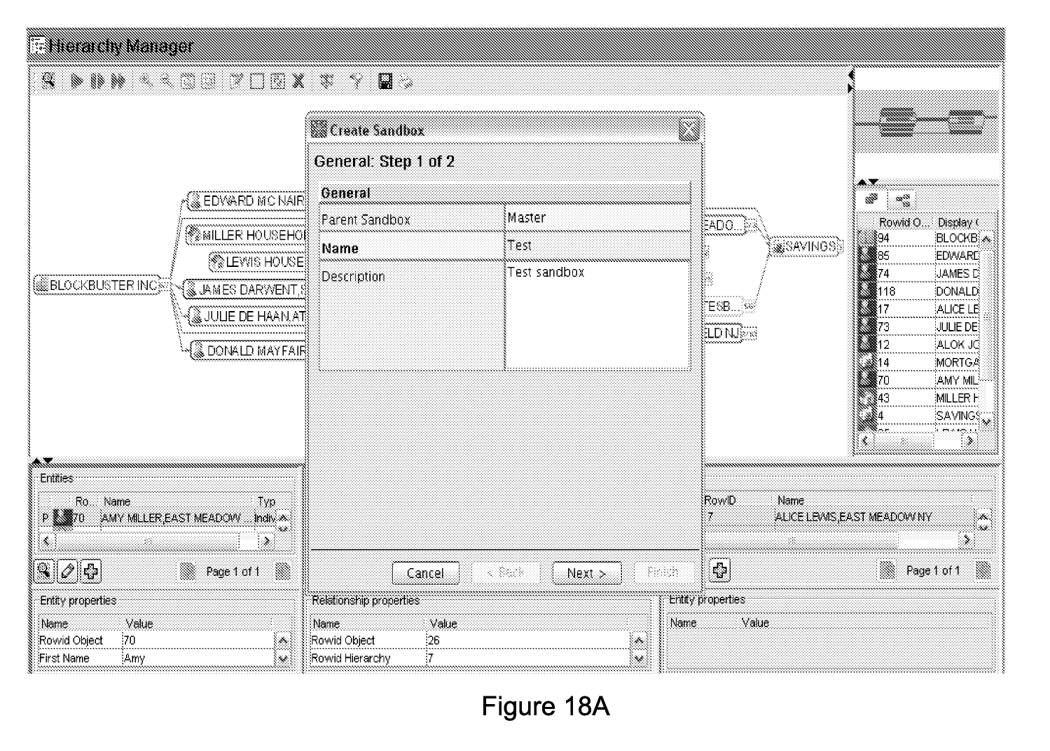

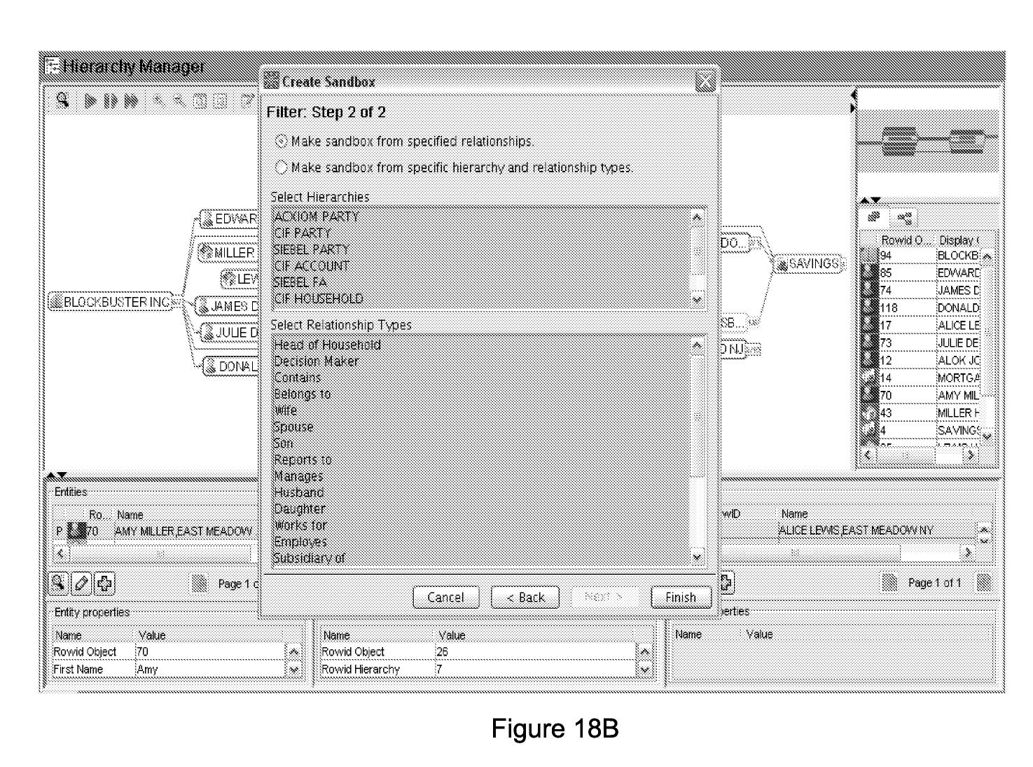

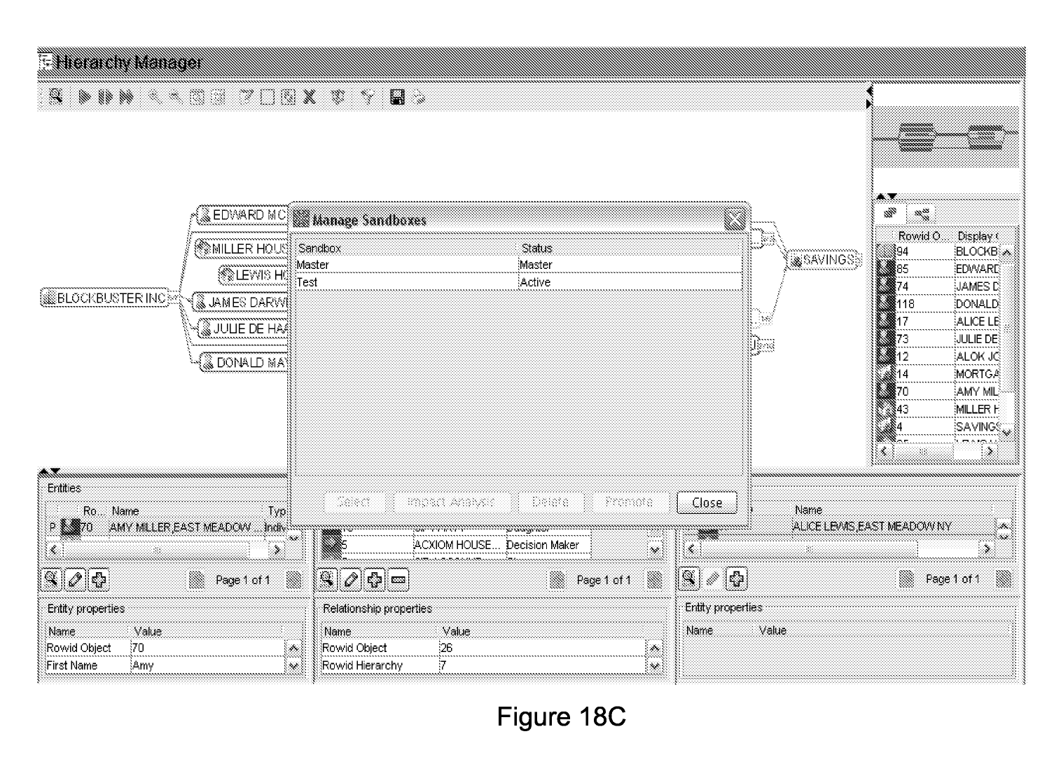

FIG. 17 is a flowchart of a sandbox method 1700 that comprises step 435 of the general method 400. The method 1700 is a process that conceptual illustrates a process of interacting with a user interface. In some embodiments, the method 1700 copies and stores the contents (entities and relationships) of a unified view to a “sandbox” storage area. In other embodiments, the method 1700 copies and stores only the relationships of a unified view to the “sandbox” storage area. The contents of the unified view in the “sandbox” storage area can then be modified or added to without affecting the original contents of the unified view in the repository. This allows the original contents of the unified view in the repository to be protected from any changes made to the contents of the unified view in the “sandbox” storage area. The method 1700 is described in relation to exemplary screenshots shown in FIGS. 18A-C.

The method 1700 proceeds from step 1530 of the update method 1500 and begins by determining (at 1705) if a request for creating a sandbox and parameters for the sandbox has been received. If so, the method 1700 copies and stores (at 1710) contents of the unified view to a sandbox storage area according to the received sandbox parameters. The contents of the unified view are stored in a “sandbox” storage area so that the contents in the “sandbox” storage area can then be modified or added to without affecting the original contents in the repository. In some embodiments, all contents of the unified view are copied and stored to the sandbox storage area. In other embodiments, only specified portions of the unified view are copied and stored to the sandbox storage area.

The exemplary screenshot of FIG. 18A shows a pop-up window UI displaying options for creating a sandbox, the pop-up window UI appearing after a request for creating a sandbox is received. In the example of FIG. 18A, sandbox parameters include the Parent Sandbox name (e.g., Master), the sandbox Name (e.g., Test), and the sandbox content Description (e.g., Test sandbox). The exemplary screenshot of FIG. 18B shows a pop-up window UI displaying further sandbox parameters, including parameters that specify particular entities and relationships of the unified view that are to be copied and stored to the sandbox (e.g., based on hierarchy and/or relationship type criteria).

After step 1710, the method 1700 then determines (at 1715) if an update to the contents of the unified view (e.g., that updates, adds, or removes an entity or relationship in the unified view) in the sandbox has been received. If so, the method 1700 updates (at 1720) the unified view in the sandbox according to the received update and stores the update in the sandbox.

The method 1700 then determines (at 1725) if a request to manage sandboxes has been received. In some embodiments, the management of sandboxes include deleting a specified sandbox or promoting a specified sandbox. In some embodiments, promoting a sandbox comprises storing the contents (entity and relationship data) of the sandbox to the storage area where the repository is stored to add to or replace the older corresponding entity and relationship data in the repository. In some embodiments, promoting a sandbox comprises storing the contents of the sandbox to the repository (e.g., to the master reference store 112 and/or data storage 180) to replace the current data stored for the modified entities and relationships in the repository. The exemplary screenshot of FIG. 18C shows a pop-up window UI for managing sandboxes, the pop-up window UI appearing after a request for managing sandboxes is received. In the example of FIG. 18C, function options for deleting a specified sandbox and promoting a specified sandbox are displayed. The method 1700 then proceeds to step 925 of the unified view build and display method 900 of FIGS. 9A-B.

As described above, the method 1700 allows modifications to the contents of a unified view to be performed in a separate sandbox storage area without affecting the original data in the repository. A user can thus modify the contents of the unified view in the sandbox until satisfied with the modifications and then store the modified sandbox contents to the repository.

### VI. Searching Related Entities

In some embodiments, the hierarchy manager allows a user to search entities (e.g., secondary entities) related to a selected entity (e.g., primary entity). Searching related entities is particularly useful when the selected entity has several related entities. For example, searching related entities is useful when the “Fetch One Hop” (direct relationship search and retrieval) or “Fetch Many Hop” (indirect relationship search and retrieval) operation retrieves several related entities. In some embodiments, the hierarchy manager allows a user to search related entities based on a single or several search parameters. In some embodiments, the hierarchy manager allows a user to search related entities based on attributes of related entities. In some embodiments, the hierarchy manager allows a user to search entities related to several selected entities.

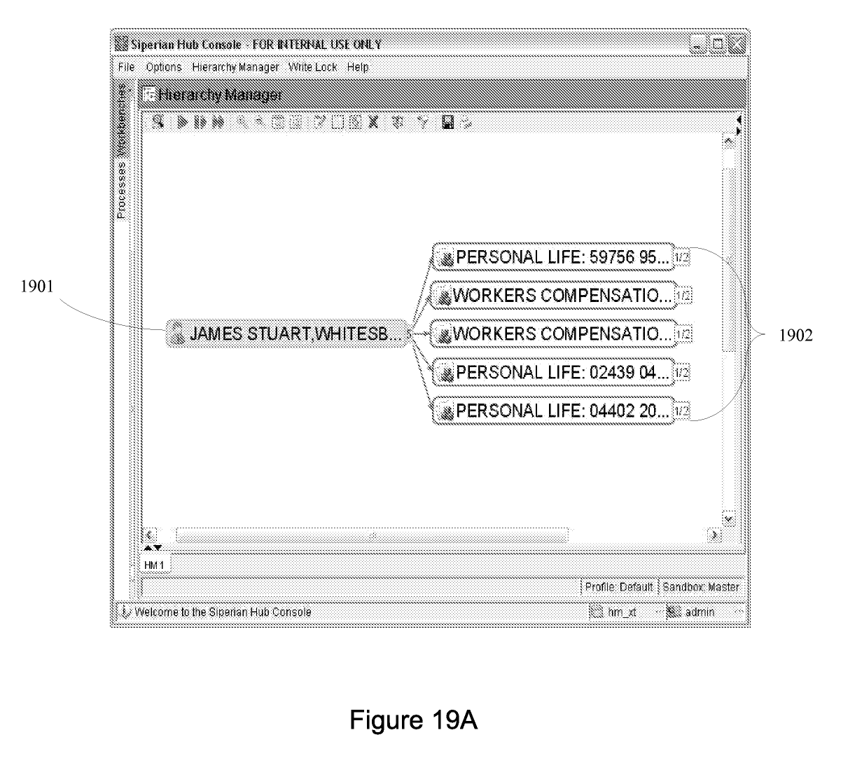

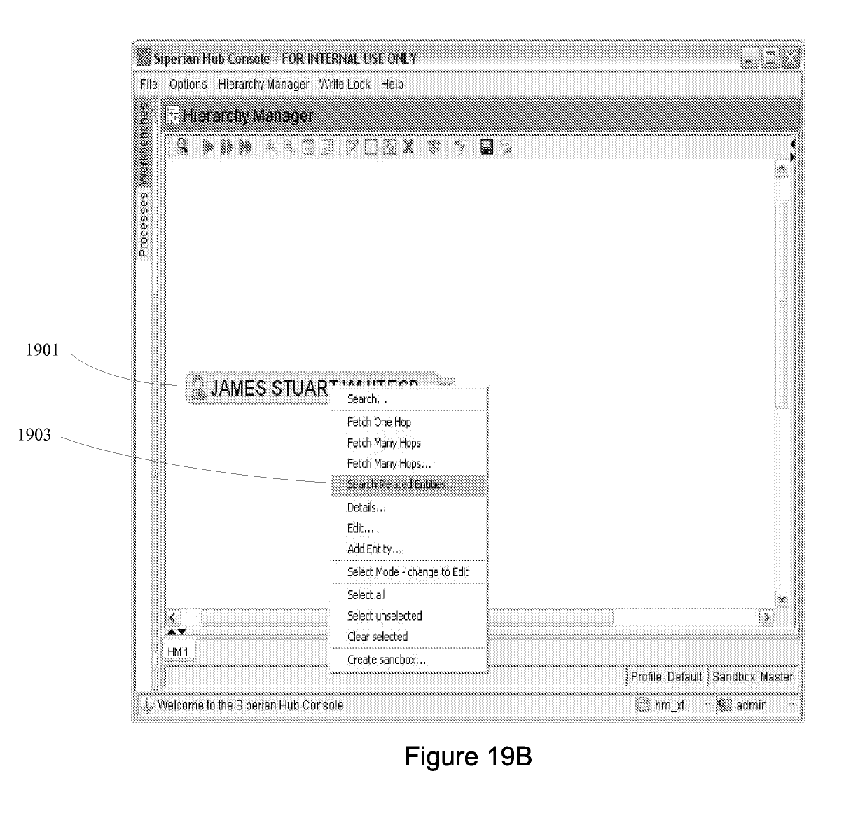

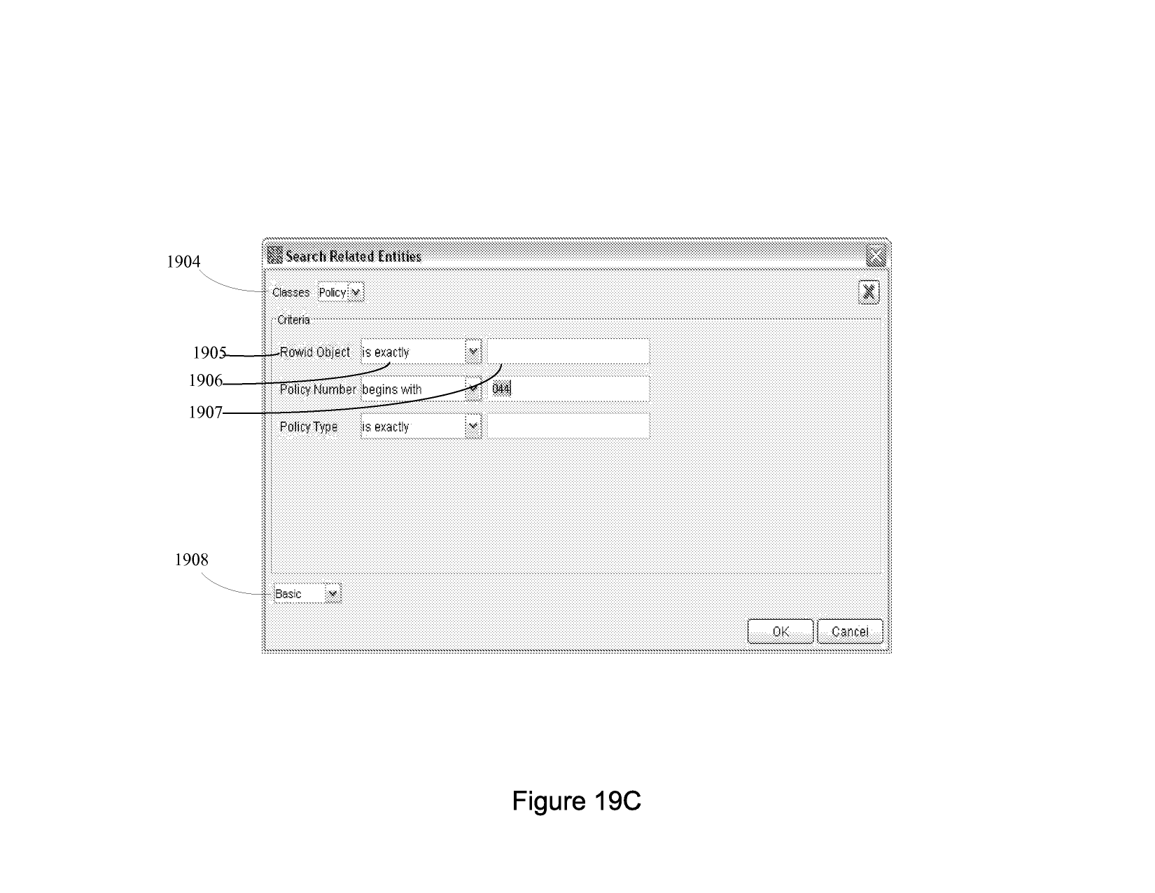

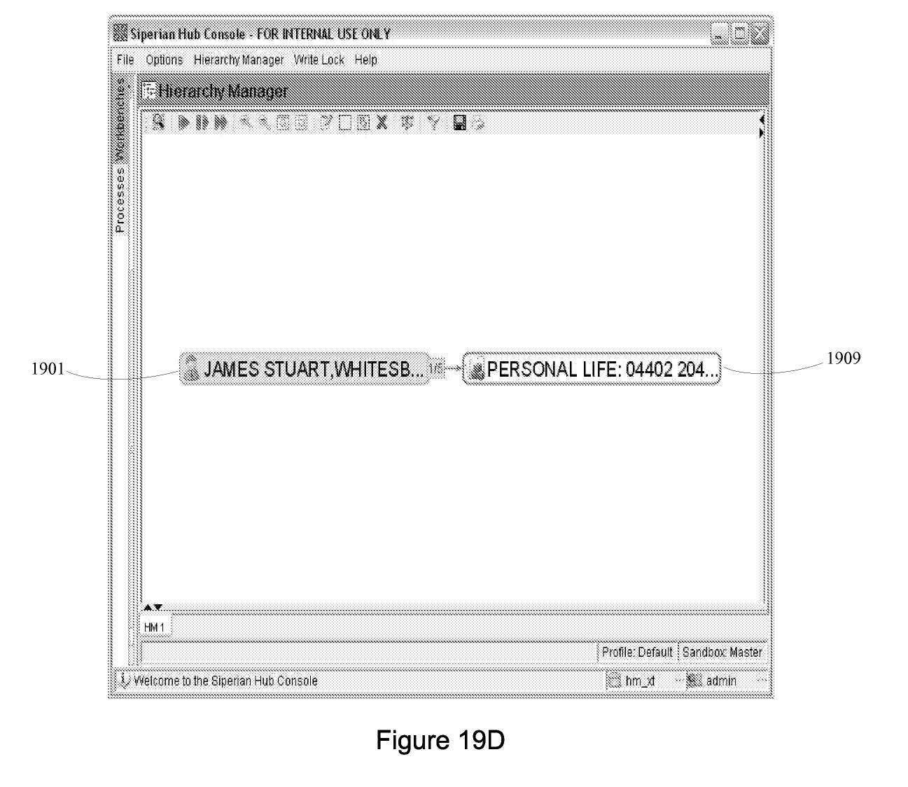

FIGS. 19A-19D are exemplary screen shots that illustrate searching entities (e.g., secondary entities) related to a selected entity (e.g., primary entity). As shown in FIG. 19A, the James Stuart entity 1901 is the selected entity that is related to several other entities 1902 (e.g., personal life, workers compensation, etc.). The exemplary screen shot of FIG. 19A shows the relationship between the James Stuart entity 1901 and the related entities 1902 after a one-hop search and retrieval operation. Rather than a one-hop search and retrieval operation, a search related entities operation allows a user to search for the related entities that satisfy a single or several search parameters. FIG. 19B shows one method (i.e., right mouse click on the selected entity) of accessing the search related entities operation 1903. However, the search related entities operation 1903 can be accessed using other methods well known in the art (e.g., using pull down menus, selecting toolbar items, etc.).

The exemplary screenshot of FIG. 19C shows a pop-up window UI for specifying search parameters for searching related entities off the James Stuart entity 1901, where the pop-up window UI appears after a request for a search related entities operation is received. In the example of FIG. 19C, the pop-up window UI has a set of search fields 1907, where each search field includes a description 1905, search filter 1906, classes list 1904, and search option 1908.

The search option 1908 allows a user to choose from several search options (e.g., basic, advanced, etc.). In the exemplary screen shot of FIG. 19, the basic search option is selected and three search fields 1907 are shown, where each search field includes a description 1905 and search filter 1906. In some embodiments, a selection of a different search option 1908 causes the number of search fields 1907 to change. For example, a selection of an advanced search option causes the number of search fields 1907 to increase, thereby allowing a user to input more search parameters than a basic search option. In some embodiments, a selection of a different search option 1908 causes the number of search filter 1906 and/or description 1905 to change.

The classes list 1904 allows a user to specify a class of entity to search for. In some embodiments, the selection of a particular entity class type customizes the description 1905 associated with the search field 1907. In some embodiments, the selection of a particular entity class type customizes the search filter 1906 associated with the search field 1907. In some embodiments, the selection of a particular class causes the number of search fields 1907 to increase, where each search field optionally includes a description 1905 and/or a search filter 1906. In some embodiments, the description 1905 is associated with an attribute of the selected class. As shown in the exemplary screen shot of FIG. 19C, the policy class is the entity class type selected, and the descriptions (i.e., Policy Number, Policy Type, etc.) are associated with the selected class (i.e., Policy).

The search filter 1906 allows a user to input a static search parameter that further limit or expand a search result. FIG. 19C shows two search filter items (i.e., is exactly, begins with). However, the search filter item can include any number of other search filter items (e.g., ends with, with at least one word, without the word, etc.). In some embodiments, the search filter 1906 is associated with the attribute of the selected entity class type. For example, the search filter for an attribute comprising a string can be different than a search filter that comprises a number. In some embodiments, the search filter 1906 is not related to any particular attribute of the selected class. In some embodiments, the search filter 1906 is a predetermined list of search filter items. In some embodiments, the search filter 1906 is a combination of predetermined and dynamic search filter items.

As shown in the FIG. 19C, any policy number (i.e., attribute of the class policy) that is related to the James Stuart entity 1901 and “begin with 044” will be returned when the user selects the confirm button (i.e., “OK” button). FIG. 19D shows the graphical view pane 505 displaying the search result after the user selected the confirm button (i.e., “OK” button). As shown, personal life policy entity 1909 is the only policy that matches the search parameters inputted (i.e., “begins with 044”) in FIG. 19C.

A selection of the cancel button closes the pop-up window UI. In other embodiments where the pop-up window UI is modal, the selection of the cancel button closes the pop-up window UI and returns to the previous window.

### VII. Bulk Relationships Add and Reassignment

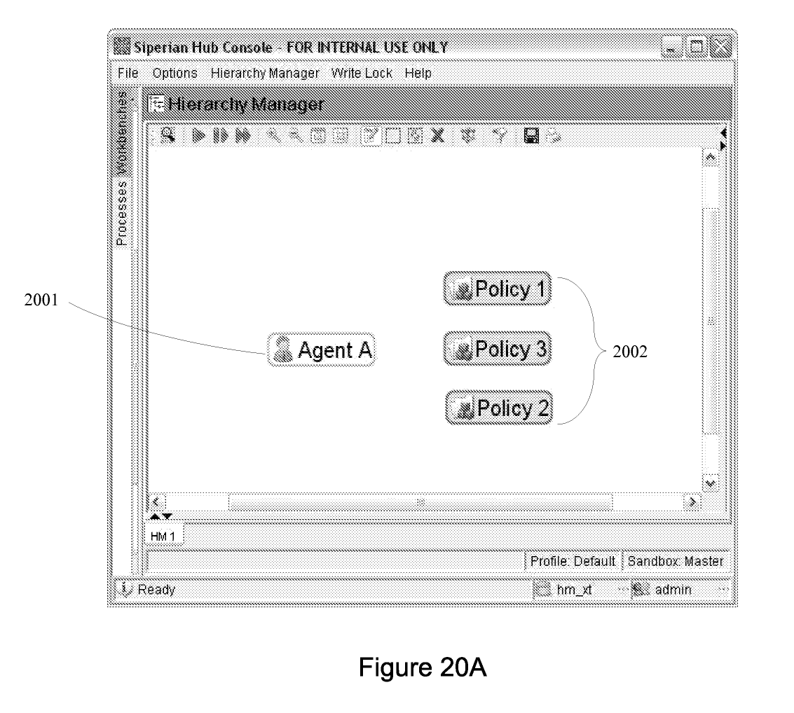

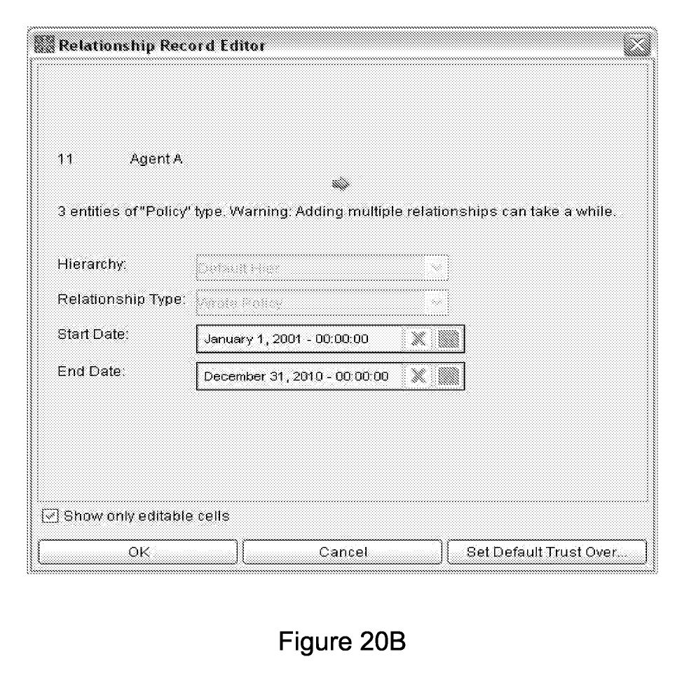

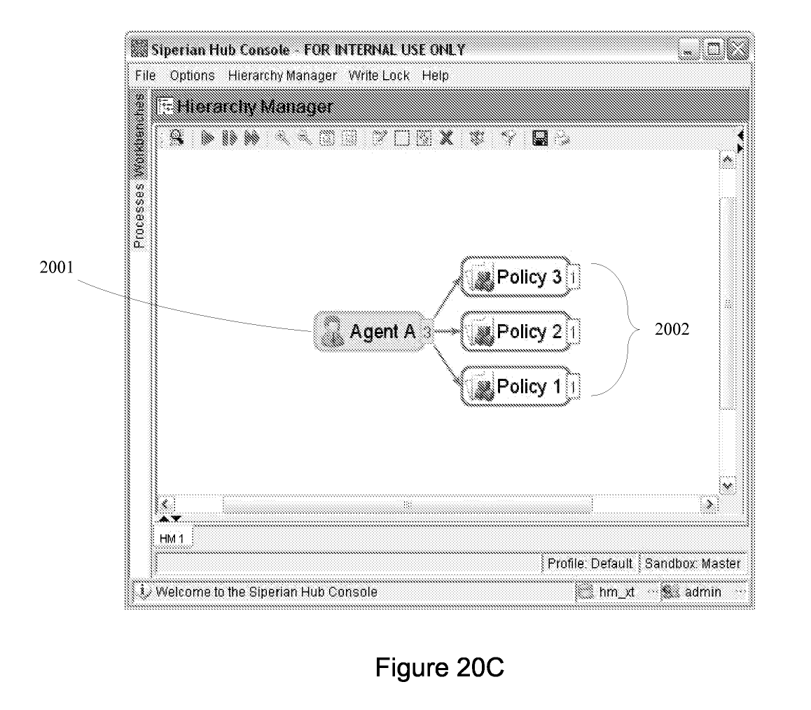

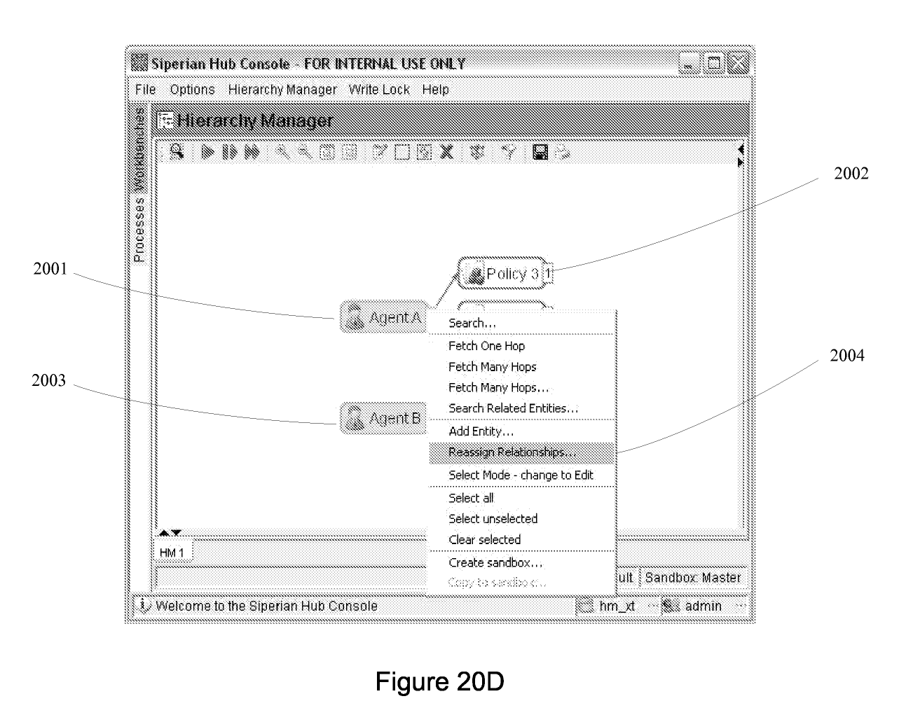

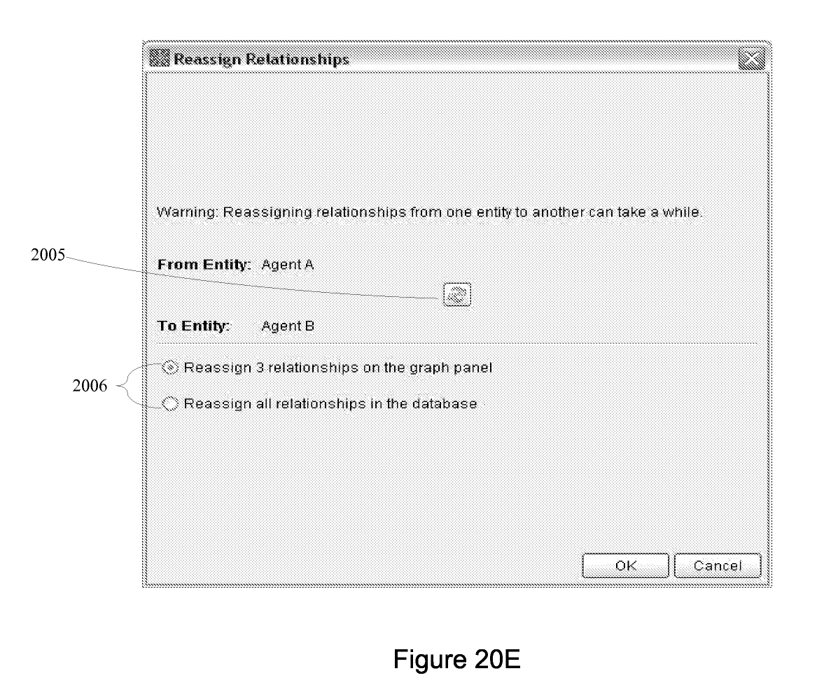

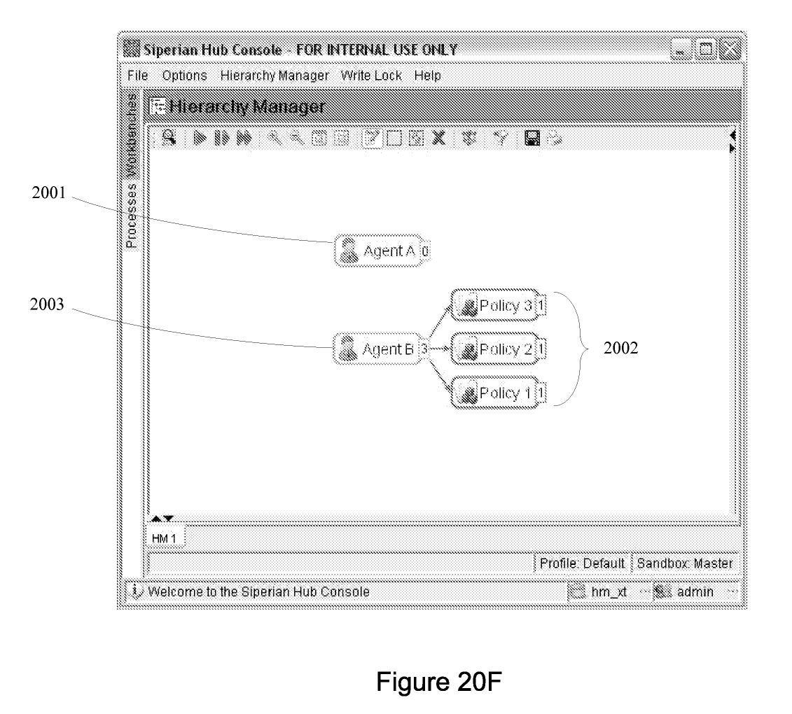

In some embodiments, the hierarchy manager allows a user to add several relationships to an entity in a bulk operation. In some embodiments, the hierarchy manager allows a user to reassign several relationships from one entity to anther entity in a bulk operation. Such bulk operations are convenient ways to quickly add a set of new relationships or reassign a set of existing relationships. The method of adding a set of relationships includes selecting several entities and selecting a target entity, where selecting a target entity creates a set of relationships between each of the several entities and the target entity. The method of reassigning a set of relationships includes selecting a first entity and second entity, and selecting the set of relationships to reassign from the first entity to the second entity. The methods of adding and reassigning a set of relationships are further described in detail with reference to FIGS. 20A-20F.

FIGS. 20A-20C are exemplary screen shots that illustrate adding several relationships to an entity in a bulk operation. In some embodiments, the method of adding a set of relationships is a drag and drop operation. FIG. 20A shows an Agent A entity 2001 (i.e., target entity) and three policy entities 2002 (i.e., several selected entities) in a graphical view pane 505. As shown in FIG. 20A, the Agent A entity 2001 is not selected (i.e., not highlighted); however, the three policy entities 2002 are selected (i.e., highlighted). One method of selecting several entities is by holding down the control button and clicking on several entities in the graphical view pane 505 or the entity listing pane 540. However, selecting several entities, like selecting several items using a computer, can be accomplished by using other methods well known in the art (e.g., holding left mouse button and dragging the mouse over the items, holding down the shift button and selecting the first and last items, etc.).

The exemplary screenshot of FIG. 20B shows a pop-up window UI for adding a set of new relationships and entering information regarding the new relationships, the pop-up window UI appearing after the three policy entities 2002 (i.e., several selected entities) is dragged and dropped onto the Agent A entity 2001 (i.e., target entities) in the graphical view pane 505. In some embodiments, each relationship type will be the same for each of the several selected entities. In some embodiments, each relationship attribute will be the same for each of the several selected entities. In some embodiments, a user can input a relationship type, relationship attributes, or hierarchy, where the inputted information is shared between each of the several selected entities. As shown in FIG. 20B, the hierarchy is a default hierarchy, the relationship type is a wrote policy, and start and end dates (i.e., relationship attributes) are Jan. 1, 2001 and Dec. 31, 2010, respectively. As shown, the hierarchy and relationship type are not user editable (i.e., shaded), and the start and end dates are user editable (i.e., not shaded).

The exemplary screenshot of FIG. 20C shows the results of the adding relationships operation specified in FIG. 20B. As shown in FIG. 20C, the Agent A entity 2001 (i.e., target entity) is now shown to be related each of the three policy entities 2002 (i.e., several selected entities).

FIGS. 20D-20F are exemplary screen shots that illustrate reassigning several relationships from one entity to anther entity in a bulk operation. FIG. 20D shows an Agent A entity 2001, three policy entities 2002, and an Agent B entity 2003 in a graphical view pane 505. As shown in FIG. 20D, the Agent A entity 2001 is related each of the three policy entities 2002, and the Agent B 2003 is not related to any of the three policy entities 2002. Further, Agent A entity 2001 and Agent B 2003 are selected (i.e., highlighted), while the three policy entities 2002 are not selected (i.e., not highlighted). The exemplary screenshot of FIG. 20D also shows one method (i.e., right mouse click on the selected entity) of accessing the reassign relationships operation 2004. However, the reassign relationships operation 2004 can be accessed using other methods well known in the art (e.g., using pull down menus, selecting toolbar items, etc.).

The exemplary screenshot of FIG. 20E shows a pop-up window UI for reassigning relationships, the pop-up window UI appearing after a request for a reassign relationships operation 2004 is received. In the example of FIG. 20E, the pop-up window UI has a switch control 2005 and several reassign options 2006.

The switch control 2005 allows a user to switch roles of the selected entities, where one entity is the giver and the other is the receiver. As shown in FIG. 20E, Agent A entity 2001 is the giver and Agent B 2003 entity is the receiver, and the selection of the switch control 2005 switches the roles of the entities, where Agent B entity 2003 becomes the giver and Agent A entity 2001 becomes the receiver.

The several reassign options 2006 allows a user to select the relationships to reassign. In some embodiments, the several reassign options 2006 allows a user to reassigns all the relationships of a first entity to a second entity. In some embodiments, the several reassign options 2006 allows a user to reassign only those relationships shown on the graphical view pane 505. The exemplary screenshot of FIG. 20D shows two reassign options 2006 (i.e., reassign 3 relationships shown in the graphical view pane 505, reassign all relationships in the database). In some embodiments, at least part of the description adjacent to a reassign option is determined at runtime as shown in FIG. 20E. In some embodiments, the number of reassign options shown is determined at runtime.

FIG. 20F shows the graphical view pane 505 displaying the reassignment of several relationships after the user selected the confirm button (i.e., “OK” button). As shown in FIG. 20F, the Agent B entity 2003 is now related each of the three policy entities 2002, and the Agent A entity 2001 is not related to any of the three policy entities 2002.

### VI. Computer System

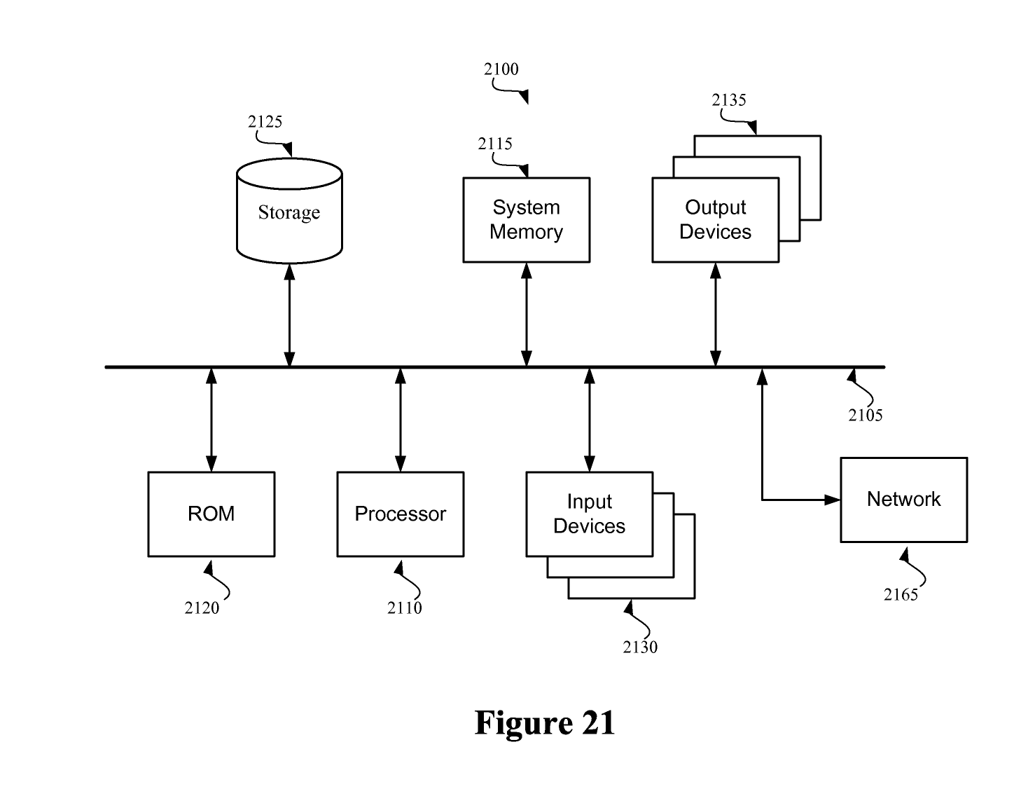

In some embodiments, the hierarchy manager is implemented by software or hardware configured to perform the various steps of the methods described herein. FIG. 21 presents a computer system 2100 with which some embodiments are implemented. The computer system 2100 includes a bus 2105, a processor 2110, a system memory 2115, a read-only memory 2120, a permanent storage device 2125, input devices 2130, and output devices 2135.

The bus 2105 collectively represents all system, peripheral, and chipset buses that communicatively connect the numerous internal devices of the computer system 2100. For instance, the bus 2105 communicatively connects the processor 2110 with the read-only memory 2120, the system memory 2115, and the permanent storage device 2125.

The read-only-memory (ROM) 2120 stores static data and instructions that are needed by the processor 2110 and other modules of the computer system. The permanent storage device 2125, on the other hand, is read-and-write memory device. This device is a non-volatile memory unit that stores instruction and data even when the computer system 2100 is off. Some embodiments use a mass-storage device (such as a magnetic or optical disk and its corresponding disk drive) as the permanent storage device 2125. Other embodiments use a removable storage device (such as a floppy disk or zip® disk, and its corresponding disk drive) as the permanent storage device.

Like the permanent storage device 2125, the system memory 2115 is a read-and-write memory device. However, unlike storage device 2125, the system memory is a volatile read-and-write memory, such as a random access memory (RAM). The system memory stores some of the instructions and data that the processor needs at runtime.

Instructions and/or data needed to perform methods of some embodiments are stored in the system memory 2115, the permanent storage device 2125, the read-only memory 2120, or any combination of the three. For example, the various memory units may contain instructions for searching, displaying, and managing data hierarchies in accordance with some embodiments. The various memory units may also contain a repository of data hierarchies or comprise a “sandbox” storage area. From these various memory units, the processor 2110 retrieves instructions to execute and data to process in order to execute the processes of some embodiments.

The bus 2105 also connects to the input and output devices 2130 and 2135. The input devices 2130 enable a user to communicate information and select commands to the computer system 2100. For instance, the input devices 2130 enable the user to input information to the computer system 2100. The input devices 2130 include alphanumeric keyboards and cursor-controllers. The output devices 2135 display images generated by the computer system 2100. For instance, these devices display a user interface (e.g., hierarchy manager user interface) through which the user can interface with the computer system 2100. The output devices include printers and display devices, such as cathode ray tubes (CRT) or liquid crystal displays (LCD).

Finally, as shown in FIG. 21, the bus 2105 also couples the computer system 2100 to a network 2165 through, for example, a network adapter (not shown). In this manner, the computer system 2100 can be a part of a network of computers (such as a local area network (“LAN”), a wide area network (“WAN”), or an Intranet) or a network of networks (such as the Internet). Any or all of the components of the computer system 2100 may be used in conjunction with some embodiments. However, one of ordinary skill in the art would appreciate that any other system configuration may also be used in conjunction with other embodiments.

One of ordinary skill will recognize that the invention can be embodied in other specific forms without departing from the spirit of the invention, even though the invention has been described with reference to numerous specific details. In view of the foregoing, one of ordinary skill in the art would understand that the invention is not to be limited by the foregoing illustrative details, but rather is to be defined by the appended claims.

What is claimed is:

1. A graphical user interface for viewing and managing a plurality of data hierarchies comprising enterprise information, each hierarchy comprising entity data regarding a plurality of entities and relationship data regarding a plurality of relationships between the entities, wherein a first hierarchy comprises data regarding a first relationship between a first entity and a second entity, and a second hierarchy comprises data regarding a second relationship between the first entity and a third entity, the interface comprising:
a view pane displaying a unified view indicating the first, second, and third entities, the first relationship between the first entity and the second entity, and the second relationship between the first entity and the third entity.

2. The interface of claim 1, wherein the unified view further indicates a third relationship between the second entity and the third entity that is established through the first entity.

3. The interface of claim 1, wherein the first and second hierarchies originate from different data sources.

4. The interface of claim 1, wherein the first and second hierarchies are integrated into a single hierarchy.

5. The interface of claim 1 further comprising:
a search interface displaying search parameters for searching the plurality of hierarchies for all relationships of the first entity and all entities related to the first entity, wherein the search interface is configured to receive search parameters from a user.

6. The interface of claim 5, wherein the displayed search parameters include searching for all direct relationships of the first entity and all entities directly related to the first entity, wherein a direct relationship does not require an intermediary entity to connect the relationship to the first entity.

7. The interface of claim 5, wherein the displayed search parameters include searching for all indirect relationships of the first entity and all entities indirectly related to the first entity, wherein an indirect relationship requires at least one intermediary entity to connect the relationship to the first entity.

8. The interface of claim 1, wherein:
the view pane comprises a graphical view pane; and
the unified view comprises a graph comprising:
node representations of the first, second, and third entities; and
connector representations of the first and second relationships.

9. The interface of claim 8, wherein the unified view further indicates a third relationship between the second entity and the third entity that is established through the first entity, the third relationship being indicated by the connector representations of the first and second relationships and the node representation of the first entity.

10. The interface of claim 8, wherein the connector representation of the first relationship comprises an arrowed line between the node representations of the first and second entities, the direction of the arrowed line indicating a particular hierarchical relationship between the first and second entities.

11. The interface of claim 8, wherein a node representation of the second entity further comprises text that specifies a relationship ratio for the entity, the denominator of the relationship ratio indicating the number of relationships to the second entity in the plurality of hierarchies that are also related to the first entity and the numerator of the relationship ratio indicating the number of these relationships that are displayed in the unified view.

12. The interface of claim 8 further comprising:
a pop-up window displaying text that specifies the first relationship between the first entity and the second entity, the pop-up window being displayed when a cursor in the graphical user interface is placed over the node representation of the second entity.

13. The interface of claim 12, wherein the pop-up window further displays text that specifies a hierarchy from which the second entity originates.

14. The interface of claim 8, wherein the interface further comprises:
an aerial view pane that displays a topological view of the graph displayed in the graphical view pane.

15. The interface of claim 8, wherein the interface further comprises:
an entity listing pane that displays a listing of all entities represented in the graph, wherein a selection of an entity listing in the entity listing pane selects the corresponding entity representation in the graph.

16. The interface of claim 1, wherein:
the view pane comprises a text view pane comprising first, second, and third regions; and
the unified view comprises:
a first text item that specifies the first entity, the first text item being displayed in the first region of the text view pane;
second and third text items that specify the second and third entities, the second and third text items being displayed in the second region of the text view pane; and
fourth and fifth text items that specify the first and second relationships, the fourth and fifth text items being displayed in the third region of the text view pane.

17. The interface of claim 16, wherein the unified view further indicates a third relationship between the second entity and the third entity that is established through the first entity, the third relationship being indicated by the first, fourth, and fifth text items.

18. The interface of claim 1 further comprising:
a filter interface displaying filter parameters for specifying types of entities or relationships to be filtered out of the unified view, wherein the filter interface is configured to receive filter parameters from a user.

19. The interface of claim 1 further comprising:
a search interface displaying search parameters for searching the plurality of hierarchies for all relationships of the second entity and all entities related to the second entity, wherein the search interface is configured to receive search parameters from a user.

20. The interface of claim 1 further comprising:
a new relationship interface displaying options to add a new relationship between the second and third entities, wherein the new relationship interface is configured to receive selected options from a user.

21. The interface of claim 1 further comprising:
a sandbox interface displaying options to copy and store the unified view to a separate storage area wherein the sandbox interface is configured to receive selected options from a user.

22. The interface of claim 1, wherein the plurality of data hierarchies comprises master reference data.

23. The interface of claim 1, wherein the plurality of data hierarchies comprises master relationship data.

24. The interface of claim 1, wherein the enterprise information comprises customer, human capital, supplier, asset, product, or financial information.

25. The interface of claim 1 further comprising:
a search interface for searching entities related to at least one selected entity, wherein the search interface is configured to receive at least one search parameter from a user.

26. The interface of claim 25, wherein the search interface comprises at least one search field with dynamic search parameters.

27. The interface of claim 1, wherein the view pane displays a fourth entity, wherein a first selection of the second and third entity, and a second selection of the fourth entity creates a third relationship between the fourth and the second entity, and a fifth relationship between the fourth and third entity.

28. The interface of claim 1, wherein the view pane displays a fourth entity, wherein a first selection of the second and third entity, and a second selection of the fourth entity reassigns the first relationship between the first and second entity to the fourth entity such that the fourth entity is related second entity, and the second relationship between the first and third entity to the fourth entity such that the fourth entity is related third entity.

29. The interface of claim 28, wherein the second selection of the fourth entity is a drag and drop operation.

30. The interface of claim 1 further comprising:
a reassign interface for reassigning at least one relationship from at least one entity to at least one other entity.

31. The interface of claim 30, wherein the reassign interface comprises a control to specify the direction of reassignment, wherein at least one entity is a giver and at least one other entity is a receiver.

32. The interface of claim 30, wherein the reassign interface comprises a control to allow a user to specify relationships to reassign.

33. A method for viewing and managing a plurality of data hierarchies comprising enterprise information, each hierarchy comprising entity data regarding a plurality of entities and relationship data regarding a plurality of relationships between the entities, wherein a first hierarchy comprises data regarding a first relationship between a first entity and a second entity, and a second hierarchy comprises data regarding a second relationship between the first entity and a third entity, the interface comprising:
displaying a unified view indicating the first relationship between the first entity and the second entity, the second relationship between the first entity and the third entity, and a third relationship between the second entity and the third entity that is established through the first entity.

34. The method of claim 33, wherein the unified view comprises a graphical view comprising:
node representations of the first, second, and third entities; and
connector representations of the first and second relationships, wherein the third relationship is indicated by the connector representations of the first and second relationships and the node representation of the first entity.

35. The method of claim 33, wherein the unified view comprises a text view comprising:
a first text item that specifies the first entity, the first text item being displayed in a first region of the unified view;
second and third text items that specify the second and third entities, the second and third text items being displayed in a second region of the unified view; and
fourth and fifth text items that specify the first and second relationships, the fourth and fifth text items being displayed in a third region of the unified view, wherein the third relationship is indicated by the first, fourth, and fifth text items.

36. The method of claim 33, wherein the first and second hierarchies originate from different data sources.

37. The method of claim 33 further comprising:
before displaying the unified view, searching the plurality of hierarchies for all relationships of the first entity and all entities related to the first entity; and
retrieving the relationships of the first entity and the entities related to the first entity from the plurality of hierarchies, wherein the unified view indicates each retrieved relationship and entity.

38. The method of claim 37, wherein the searching comprises searching the plurality of hierarchies for all direct relationships of the first entity and all entities directly related to the first entity.

39. The method of claim 38, wherein the searching further comprises searching the plurality of hierarchies for all indirect relationships of the first entity and all entities indirectly related to the first entity, wherein an indirect relationship requires at least one intermediary entity to connect the relationship to the first entity.

40. The method of claim 37 further comprising:
receiving filtering parameters that specify types of entities or relationships to be filtered out of the unified view; and
removing from the unified view particular entities or relationships based on the received filtering parameters.

41. The method of claim 33 further comprising:
displaying text in the unified view that specifies the first relationship between the first entity and the second entity; and
displaying text in the unified view specifying an identifier of the first hierarchy.

42. The method of claim 33 further comprising:
displaying text in the unified view that specifies a relationship ratio for the second entity, the denominator of the relationship ratio indicating the number of relationships to the second entity in the plurality of hierarchies that are also related to the first entity and the numerator of the relationship ratio indicating the number of these relationships that are displayed in the unified view.

43. The method of claim 33 further comprising:
searching the plurality of hierarchies for all relationships of the second entity and all entities related to the second entity;
retrieving the relationships of the second entity and the entities related to the second entity from the plurality of hierarchies; and
displaying each retrieved relationship and entity in the unified view.

43. The method of claim 33 further comprising:
receiving updated information regarding an entity or relationship displayed in the unified view; and
updating the unified view according to the received updated information.

44. The method of claim 33, wherein the updated information comprises a new relationship between two particular entities in the unified view, the two particular entities originating from different hierarchies.

45. The method of claim 33 further comprising:
copying and storing the unified view to a separate storage area.

46. The method of claim 45 further comprising:
receiving modification to the unified view stored in the separate storage area;
modifying the unified view stored in the separate storage area according to the received modifications; and
storing the contents of the modified unified view to the storage area where the plurality of hierarchies is stored to add or replace data in the plurality of hierarchies.

47. The method of claim 33 further comprising:
receiving selection of at least one entity;
receiving at least one search parameter from a user;
based on the search parameter, searching for entities related to the selected entity.

48. The method of claim 47, wherein a search parameter is based on a class type of the selected entity.

49. The method of claim 33 further comprising providing at least one control for adding a set of relationships to a selected entity.

50. The method of claim 33 further comprising providing at least one control for reassigning at least one relationship from at least one entity to at least one other entity.

51. The method of claim 50, wherein a control allows a user to specify relationships to reassign.

52. The method of claim 50, wherein a control allows a user to specify the direction of reassignment, wherein at least one entity is a giver and at least one other entity is a receiver.
